(19) United States
(12) Patent Application Publication
(10) Pub. No.: US 2024/0411272 A1
(43) Pub. Date: Dec. 12, 2024

(54) SYSTEM AND METHOD FOR DETERMIING A TIME INTERVAL OF A SPORTING EVENT

(71) Applicant: BY A NOSE, LLC, Boyd, TX (US)

(72) Inventors: Alan Woodbury, Dickinson, ND (US); Andrew Gikling, Roseville, MN (US); David Hall, Robbinsdale, MN (US); Taylor Heck, Champlin, MN (US); Yann Talhouarne, Saint Paul, MN (US); Shaun Maher, Timber Lake, SD (US)

(73) Assignee: BY A NOSE, LLC, Boyd, TX (US)

(21) Appl. No.: 18/736,433

(22) Filed: Jun. 6, 2024

Related U.S. Application Data
(60) Provisional application No. 63/471,430, filed on Jun. 6, 2023.

(51) Int. Cl. G04F 10/00

(52) U.S. Cl. CPC G04F 10/00

(57) ABSTRACT

System and methods for determining time intervals of sporting events having a transmitting device that has multiple light transmitters configured to communicate light signals, a receiving device communicatively connected to the transmitting device via multiple receivers configured to receive the light signals communicated from the transmitters. The light signals being configurable into an electronic gate extending between the transmitting device and the receiving device such that light signals between the transmitters and receivers form the gate, and a pendant device communicatively connected to the transmitting device and the receiving device in a closed network that enables additional similar networks to be established without interfering with the determination of time intervals.

### CROSS-REFERENCE TO RELATED APPLICATION

This application claims the benefit of priority from U.S. Provisional Application No. 63/471,130 which was filed Jun. 6, 2023, and which is incorporated by reference herein in its entirety.

### FIELD OF THE DISCLOSURE

The disclosure generally relates to systems and methods for measuring a time interval of at sporting events. More particularly the disclosure relates to systems and methods for accurately determining time intervals during a sport event, such as rodeo events.

### BACKGROUND OF THE INVENTION

Time is often the all-important measure of success for participants in sporting events. Typically, time keeping technology at sporting events can include an individual timekeeper having a stopwatch measuring time, a participant wearing tracking chips or monitors, and the like. However, current time keeping technology typically includes a margin of error that could affect the determination of the winner of the sporting event.

In the field of rodeo sports, for example, current systems and methods used to measure time of at events can result in time measure with a margin of error. Current systems used to determine timing in rodeo sporting events have an electronic finish line that does not account for the varying size and/or shape or physical geometry of the participants (e.g., size and/or shape of the horse). For example, the time of the rodeo sporting event may be inaccurately calculated due to different body parts of the horse crossing the finish line at different times due to the height difference between horses. For example, the chest or neck of taller horses may cross the electronic finish line first when in actuality the muzzle of the horse crossed the plan of the finish line first. As such, there is a need to develop a system and method to accurately measure the time of all participants participating in sporting events, specifically rodeo sporting events.

### SUMMARY OF THE INVENTION

Systems, comprising a light transmitting device that comprises a transmitting member and a transmitting assembly positioned within the transmitting member, wherein the transmitting assembly further comprises at a plurality of light transmitters configured to communicate light signals, and a support assembly connected to the transmitting member; a receiving device communicatively connected to the transmitting device to communicate data between them, wherein the receiving device comprises: a receiving member, a receiving assembly positioned within the receiving member, wherein the receiving assembly further comprises a plurality of light receivers configured to receive the light signals from the plurality of transmitters; and a support assembly connected to the receiving member; and a user device communicatively connected to the transmitting device and the receiving device to communicate data between them.

The plurality of light transmitters of the transmitting assembly may comprise a first light transmitter, a second light transmitter positioned between the first light transmitter and the support assembly, a third light transmitter positioned between the second transmitter and the support assembly, and a fourth light transmitter positioned between the third light transmitter and the support assembly.

A first light transmitter can be positioned approximately 56 inches above a surface. The fourth light transmitter can be positioned approximately 36 inches above a surface.

The signals communicated by the plurality of light transmitters further comprises a plurality of rays of light.

Methods, comprising positioning the light transmitting device at a first predetermined location; positioning the light receiving device at a second predetermined location opposite the light transmitting device at a distance from the light transmitting device; establishing a data network that comprises the light transmitting device, the light receiving device, and a pendant device; aligning a plurality of light transmitters of the transmitting device and a plurality of light receivers of the receiving device; generating an electronic gate between the light transmitting device and the light receiving device via each of the plurality of light transmitters that communicate one or more light signals such that the one or more light signals are received by the plurality of light receivers of the receiving device; determining the time interval of the sporting event, comprising: determining a first interruption of a ray of light of the one or more light signals communicated by one of the plurality of light transmitters; determining a first-time stamp of the first interruption of a ray of light of the one or more signals communicated by one of the plurality of light transmitters; rearming the electronic gate after a period of time; determining a second interruption of a ray of light of the one or more light signals communicated by one of the plurality of light transmitters; determining a second-time stamp of the second interruption of a ray of light of the one or more light signals communicated by one of the plurality of light transmitters; determining a time interval of the sporting event based on the first-time stamp and the second-time stamp; and communicating the determined time interval of the sporting event.

A clock component may be utilized in determining the first-time stamp and the second-time stamp, and in determining the time interval.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a schematic view of an exemplary system in accordance with aspects of the present disclosure.

FIG. 2 is a perspective side view of an exemplary light transmitting device in accordance with the present disclosure.

FIG. 3 is a schematic diagram of an exemplary transmitting assembly of the light transmitting device in accordance with the present disclosure.

FIG. 4 is a side plan view of an exemplary positioning member of an exemplary support assembly of the light transmitting device in accordance with the present disclosure.

FIG. 5 is a top plan view of an exemplary connecting member of the exemplary support assembly of the light transmitting device in accordance with the present disclosure.

FIG. 6 a side plan view of the exemplary connecting member of the exemplary support assembly of the light transmitting device in accordance with the present disclosure.

FIG. 7 is a top plan view of an exemplary bracing member of the exemplary support assembly of the light transmitting device in accordance with the present disclosure.

FIG. 8 is a perspective side view of an exemplary bracing member of the exemplary support assembly of the light transmitting device in accordance with the present disclosure.

FIG. 9 is a side plan view of an exemplary reinforcing member of the light transmitting device in accordance with the present disclosure.

FIG. 10 is a perspective side view of the light receiving device in accordance with the present disclosure.

FIG. 11 is a schematic diagram of an exemplary receiving assembly of the light receiving device in accordance with the present disclosure.

FIG. 12 is a side plan view of an exemplary positioning member of an exemplary support assembly of the light receiving device in accordance with the present disclosure.

FIG. 13 is a top plan view of an exemplary connecting member of the exemplary support assembly of the light receiving device in accordance with the present disclosure.

FIG. 14 is a side plan view of an exemplary connecting member of the exemplary support assembly of the light receiving device in accordance with the present disclosure.

FIG. 15 is a top plan view of an exemplary bracing member of the exemplary support assembly of the light receiving device in accordance with the present disclosure.

FIG. 16. is a perspective side view of an exemplary bracing member of the exemplary support assembly of the light receiving device in accordance with the present disclosure.

FIG. 17 is a side plan view of an exemplary reinforcing member of the light receiving device in accordance with the present disclosure.

FIG. 18 is a perspective side view of another implementation of an exemplary light transmitting device.

FIG. 19 is a perspective side view of another implementation of an exemplary light receiving device.

FIG. 20 is a front plan view of an exemplary pendant device of the system in accordance with the present disclosure.

FIG. 21 is a diagrammatic view of the exemplary pendant device for use in the system in accordance with the present disclosure.

FIG. 22 is a flowchart of an exemplary method of determining a time interval in accordance with one aspect of the present disclosure.

FIG. 23A is a schematic diagram of the transmission of an output signal from an exemplary first light transmitter in accordance with the present disclosure.

FIG. 23B is a schematic diagram of the transmission of the output signal from an exemplary second light transmitter in accordance with the present disclosure.

FIG. 23C is a schematic diagram of the transmission of an output signal from an exemplary third light transmitter in accordance with the present disclosure.

FIG. 23D is a schematic diagram of the transmission of an output signal from an exemplary fourth light transmitter in accordance with the present disclosure.

FIG. 24 is a schematic diagram of an electronic gate in accordance with the present disclosure.

### DETAILED DESCRIPTION OF THE DRAWINGS

The following detailed description refers to the accompanying drawings. The same reference numbers in different drawings may identify the same or similar elements. Before explaining at least one implementation of the disclosure in detail, it is to be understood that the disclosure is not limited in its application to the details of construction, experiments, exemplary data, and/or the arrangement of the components set forth in the following description or illustrated in the drawings unless otherwise noted.

The disclosure is capable of other implementations or of being practiced or carried out in various ways. It should also be understood that the phraseology and terminology employed herein for purposes of description and should not be regarded as limiting.

The methods and mechanisms proposed in this disclosure circumvent the problems described above. The present disclosure describes systems and methods for accurately determining a time interval for sporting events.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the implementations herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein any reference to “one implementation” or “an implementation” means that a particular element, feature, structure, or characteristic described in connection with the implementation is included in at least one implementation. The appearances of the phrase “in one implementation” in various places in the specification are not necessarily all referring to the same implementation.

Circuitry, as used herein, may be analog and/or digital components, or one or more suitably programmed processors (e.g., microprocessors) and associated hardware and software, or hardwired logic. Also, “components” may perform one or more functions. The term “component,” may include hardware, such as a processor (e.g., microprocessor), an application specific integrated circuit (ASIC), a field programmable gate array (FPGA), a combination of hardware and software, and/or the like. The term “processor” as used herein means a single processor or multiple processors working independently or together to collectively perform a task.

Software may include one or more computer readable instructions, also referred to as executable code, that when executed by one or more components cause the component to perform a specified function. Persons of ordinary skill in the art will understand that the algorithms described herein may be stored on one or more non-transitory computer readable medium.

Exemplary non-transitory computer readable mediums may include random access memory (“RAM”), read only memory (“ROM”), flash memory (“FLASH”), and/or the like. Such non-transitory computer readable mediums may be electrically based, optically based, magnetically based, and/or the like. Non-transitory computer readable medium may be referred to herein as non-transitory memory.

As discussed above, there is a need to develop a new system and method for accurately measuring a time interval for all participants in a sporting event, to include participants of various stature and builds. As such, there is a need to develop a new system and method to accurately determine a time interval by which a participant is participating in a sporting event.

The present disclosure by way of example, but in no way limiting, addresses these deficiencies with methodologies and systems of determining a time interval for sporting events.

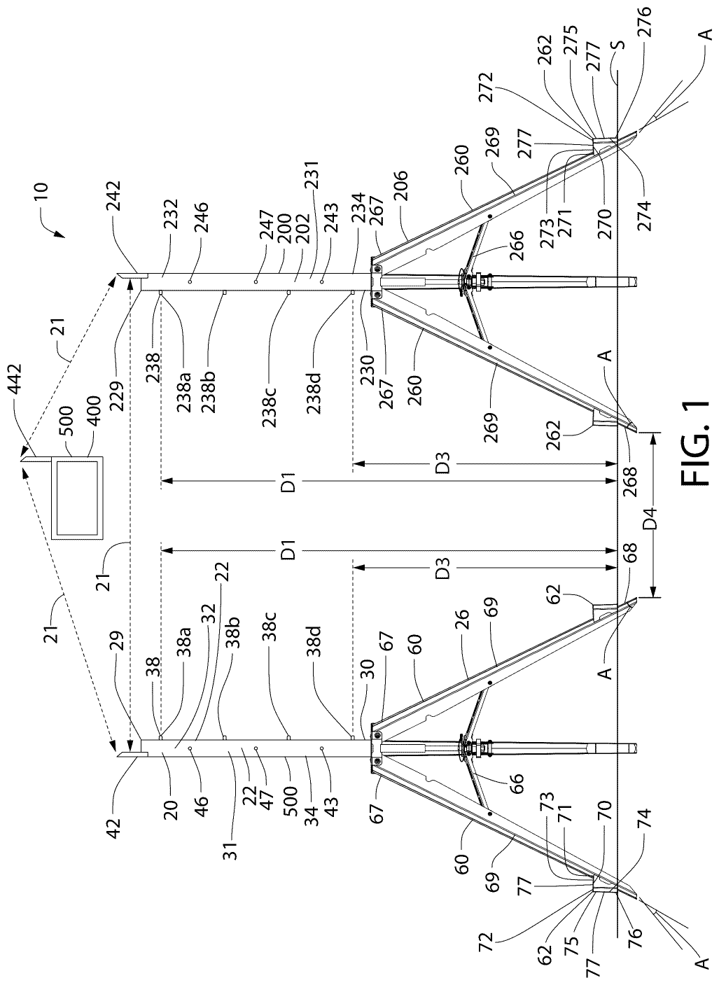

Referring now to the drawings, FIG. 1 illustrates a schematic diagram of an exemplary system for determining a time interval in accordance with the present disclosure. The system may have a light transmitting device 20, a light receiving device 200, and a pendant device 400 in accordance with the present disclosure. It should be noted, FIG. 1 does not represent the spatial relationship between light transmitting device 20, light receiving device 200, and pendant device 400. Light transmitting device 20, light receiving device 200, and pendant device 400 of the system 10 may act as nodes configured to generate a wireless network 21. In one implementation, wireless network 21 may have a 900 MHz, 2.4 GHz, 4.9 GHz, 5 GHz, 5.9 GHz, 6 GHz, and 60 GHz Wi-fi/Bluetooth frequency band. In other implementations, network 21 of system 10 may include data communications radio technology such as lower frequency RF, longer range LORA WAN, XBEE, Thread, Bluetooth, Zigbee, or the like.

System 10 may be configured such that if light transmitting device 20, light receiving device 200, and/or pendant device 400 fails to function in accordance with the present disclosure, light transmitting device 20, light receiving device 200, and/or pendant device 400 may be replaced within system 10 by a second light transmitting device 20, second light receiving device 200, and/or second pendant device 400 without configuring the second light transmitting device 20, second light receiving device 200, and/or second pendant device 400 to function with the first transmitting device 20, receiving device 200, and/or pendant device 400.

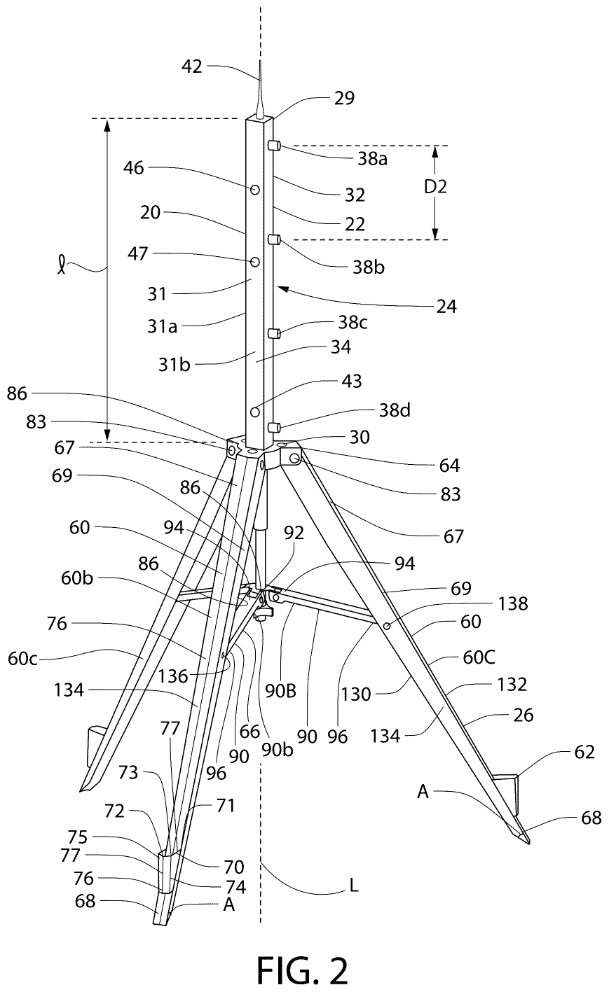

As seen in FIG. 2, light transmitting device 20 of system 10 may have a light transmitting member 22, a transmitting assembly 24 positioned within and supported by the transmitting member 22, and one or more support assembly 26. The transmitting member 22 of the transmitting device 20 may have a first end 29, a second end 30, and at least one sidewall 31 extending from the first end 29 to the second end 30 such that the at least one sidewall 31 defines a bore (not shown) extending from the first end 29 to the second end 30 of the transmitting member 22. The transmitting member 22 may have a first portion 32 and a second portion 34. The first portion 32 of the transmitting member 22 may be positioned adjacent the first end 29 of the transmitting member 22. The second portion 34 of the transmitting member 22 may be positioned adjacent the second end 30 of the transmitting member 22.

In some implementations, the transmitting member 22 may have a length 1 extending from the first end 29 to the second end 30 of the transmitting member 22. In some implementations, the transmitting member 22 may have a first sidewall 31a and a second sidewall 31b. The first sidewall 31a of the transmitting member 22 may be connected to the second sidewall 31b of the transmitting member 22 by one or more fastener (not shown). The fastener may be a screw, pin, nail, or the like. The at least one sidewall 31 of the transmitting member 22 may be metal, plastic, or the like.

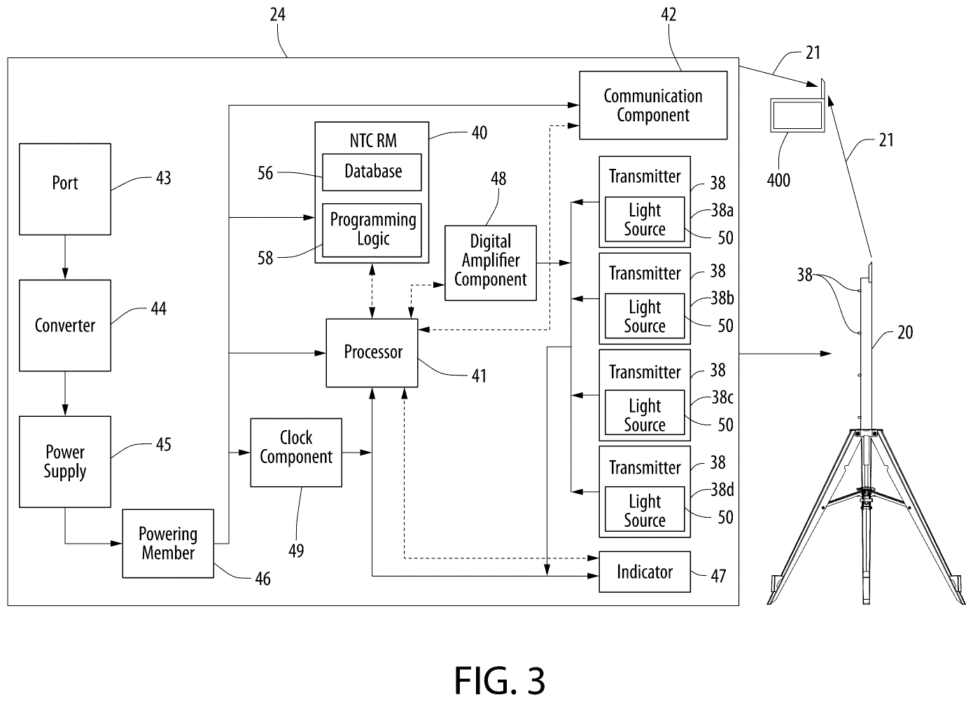

FIG. 3 discloses a schematic diagram of an exemplary transmitting assembly 24 of light transmitting device 20 in accordance with the present disclosure. The transmitting assembly 24 of light transmitting device 20 may have one or more light transmitter(s) 38 supported by the one or more sidewall 31 of the transmitting member 22, one or more non-transitory computer-readable storage medium 40, one or more processor 41, one or more communication component 42, a port 43, a converter 44, one or more power supply 45, and a powering member 46. In some non-limiting implementations, transmitting assembly 24 may have one or more indicator 47. In some non-limiting implementations, transmitting assembly 24 may have a digital amplifier component 48. In some non-limiting implementations, transmitting assembly 24 may have a clock component 49. The clock component 49 may be configured to measure the passage of time. In some non-limiting implementations, transmitting device 20 may have a power management unit that may include port 43, power supply 45, and powering member 46. The power management unit may be configured to output power to the components of transmitting assembly 24. Transmitting assembly 24 may be positioned within the bore of transmitting member 22 such that one or more light transmitter(s) 38 of the transmitting assembly 24 is positioned between a height of approximately 36 inches to approximately 56 inches above a surface S.

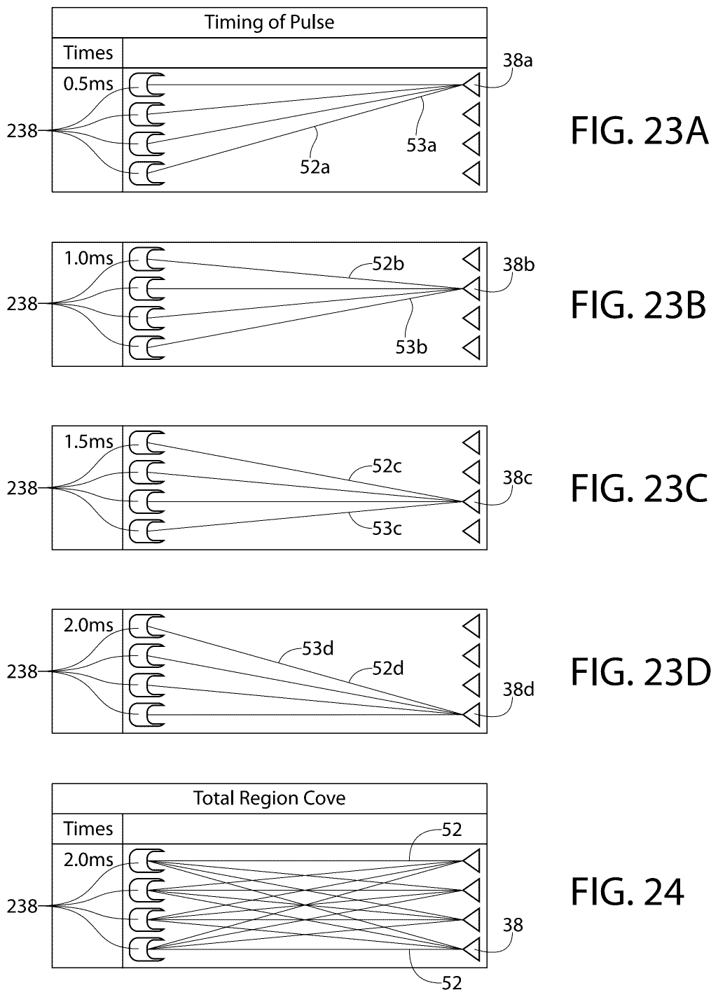

In some non-limiting implementations, transmitter(s) 38 of transmitting assembly 24 may have a light source 50. The one or more transmitter 38 of the transmitting assembly 24 may be supported by the at least one sidewall 31 of the transmitting member 22. In some non-limiting implementations, the light source 50 be a light emitting diode (LED) or other source of light. In other non-limiting implementations, transmitter(s) 38 of transmitting assembly 24 may be laser(s). As illustrated in FIGS. 23A-23D and FIG. 24, transmitter(s) 38 may be configured to transmit a light signal 52 in the form of an optical beam or a plurality of rays of light responsive to a signal from one or more communication component 42. In some implementations, transmitter(s) 38 may be configured to transmit an output light signal 52 in the form of infrared light, visible light, laser light or the like. In some implementations, the infrared wavelength of the transmitter may be approximately 920 nm. The light output signal 52 may have spatial resolution such that output signal 52 may be configured to generate an electronic gate 54. The higher the spatial resolution of output light signal 52 the more accurate the determination of the time interval. In some non-limiting implementations, the plurality of transmitters 38 may have a half angle such that the intensity of output light signal 52 may be higher near transmitter(s) 38 and lower when away from transmitter(s) 38. In some non-limiting implementations, the half angle may be approximately 20°±approximately 10°.

As illustrated in FIGS. 23A-D and FIG. 24, each individual light transmitter 38 projects a beam of light that can be detected by multiple light detectors 238. For example, FIG. 23A illustrates that the highest light transmitter 38 emits a series of light beams or signals 52 that are detected by each of the four (4) light detectors 238 on light receiver assembly 200. Given the different angles of incidence between the light transmitter 38 and each of the light detectors 238, different timing will occur when one or more of those beams are broken by the passage of a participant in the event. When four (4) transmitters (38) and four detectors (238) are utilized, there are effectively sixteen (16) beams traveling between transmitter assembly 20 and receiver assembly 200 (see, e.g., FIG. 24), which forms a curtain of light through which the event participant passes (since the “curtain of light” is only 4-16 beams which are operated for extremely short durations, the participants will likely not notice the light). The curtain of light enables the systems and methods of the disclosure to determine more accurate timing intervals because these systems and methods can detect when different parts of a participant pass through the curtain of light regardless of the height and/or specific body contour of the participant. Persons of ordinary skill in the art will appreciate that the number of light transmitters 38 and light detectors 238 may be increased or decreased depending on the desired quality of timing. For example, an increase to five (5) pairs of transmitters and detectors would result in a light curtain formed by 25 light beams as compared to the embodiment described above with 16 light beams.

In other implementations, transmitting assembly 24 may have a plurality of transmitters 38a, 38b, 38c, 38d, . . . 38n (See FIG. 3). The reference number 38a, 38b, 38c, . . . 38n may be used interchangeably with the reference number 38. In the illustrated implementation, transmitting assembly 24 has four transmitters 38a-38d. Persons of ordinary skill in the will appreciate that the number of transmitters 38 can vary as needed. By way of example, but in no way limiting, the transmitting assembly 24 may have one transmitter 38 up to ten or more transmitters 38. In cases where the transmitting assembly 24 has multiple transmitters 38, each transmitter 38 may be configured to transmit the output signal 52 at a different frequency. Alternatively, the multiple transmitters 38 may be configured to transmit the output signal 52 at a substantially similar frequency. The one or more transmitter 38 of transmitting assembly 24 may be configured to transmit a plurality of output light signals 52 may have various frequencies and wavelengths. In some non-limiting implementations, the output light signal 52 may be approximately 56 kilohertz. In some non-limiting implementations, the output light signal 52 may have a wavelength of approximately 920 nanometers. The plurality of transmitters 38 may be disposed within and supported by one or more sidewall(s) 31 of transmitting member 22 of transmitting device 20.

As seen in FIG. 1, by way of example, but in no way limiting, a first transmitter 38a of the transmitting assembly 20 may be positioned a first distance D1 from the surface S. In a preferred implementation, the first transmitter 38a may be positioned approximately 56 inches from the surface S. Subsequently arranged transmitters 38b, 38c, etc., are spaced a distance D2, i.e., an intra-transmitter distance D2 (FIG. 2). The second distance D2 may be consistent for the plurality of transmitters 38 disposed within and supported by one or more sidewall(s) 31 of transmitting member 22. In some implementations, the last transmitter 38n of the transmitting assembly may be positioned a distance D3 from the surface (see, e.g., FIG. 1, reference numeral 38d). In a preferred implementation, the last transmitter 38n may be positioned approximately 36 inches from the surface S. The positioning of the plurality of transmitters 38 within one or more sidewall(s) 31 of the transmitting member 22 may be configured to selectively transmit an output light signal 52 from each transmitter 38 thereby generating an electronic gate 54 comprising a plurality of output light signals 52 (see, e.g., FIG. 24) extending between the plurality of transmitters 38 of transmitting device 20 and the plurality of receivers 238 of receiving device 200. In some non-limiting implementations, the one or more transmitter 38 may be configured to transmit the one or more output signal 52.

The one or more non-transitory computer-readable storage medium 40; i.e., non-transitory memory, of transmitting assembly 24 (FIG. 3) of transmitting device 22 may have one or more structured database 56 and program logic 58. The non-transitory computer-readable storage medium 40 may be configured to store processor executable code and/or information within one or more structured database 56 and program logic 58.

The structured database 56 of the non-transitory computer-readable storage medium 40 may be a database, a data table, or the like. The structured database 56 of the non-transitory computer readable medium 40 may include processor executable instructions and/or code capable of being executed by the one or more processor 41. Program logic 58 of the non-transitory computer-readable storage medium 40 may have processor executable instructions and/or code, which when executed by the processor, may cause the processor to execute the commands programmed within the instructions and/or code. In some implementations, program logic 58 may be executed for transmitting device 20 by one or more processor(s) 41 and/or program logic 58 may be executed in a networked environment including, but not limited to, the transmitting device 20, the receiving device 200, and pendant device 400. In addition, the networked environment may also be accessed by a mobile device via a dedicated app and/or a browser webpage or the like. The processor executable instructions and/or code may be in the form of software and/or firmware, written in any suitable programming language. Suitable programming language may be C, C++, Python, Java, Javascript, SQL, and the like.

Processor(s) 41 of transmitting assembly 24 may be implemented as a single unit processor, separate processors, multi-core processor, including but not limited to microprocessors, working together or independently to, execute processor executable instructions and/or code stored on structured database 56 and/or program logic 58 described herein. Processor(s) 41 may be configured to communicate with transmitter(s) 38, non-transitory computer readable medium 40, communication component 42, and/or indicator 47 via one or more data path(s). Processor(s) 41 may be capable of reading and/or executing processor executable instructions and/or creating, manipulating, altering, and/or storing computer data structure into the one or more non-transitory computer readable medium 40 of transmitting assembly 24.

Processor(s) 41 may be configured to execute processor executable instructions stored on structured database 56 and/or execute program logic 58 such that when executed by processor(s) 41 causes processor(s) 41 to bi-directionally communicate data to transmitter(s) 38 thereby causing transmitter(s) to transmit light output signal 52. Processor(s) 41 may be configured to execute processor executable instructions stored on structured database 56 and/or execute program logic 58 such that when executed by processor(s) 41 causes processor(s) 41 to bi-directionally communicate data with the communication component 42 in order to generate, maintain, provide, and/or host network 21 consisting of at least transmitting device 20, receiving device 200, and pendant device 400 and/or to communicate with the receiving device 200 and/or pendant device 400 of the system 10.

One or more mobile device(s) may also communicate with devices on network 21 via a dedicated app and/or via a browser webpage or through other access. In some non-limiting implementations, processor(s) 41 may be configured to execute processor executable instructions stored on structured database 56 and/or execute program logic 58 such that when executed by processor(s) 41 causes processor(s) 41 to bi-directionally communicate with the communication component(s) 42 to generate, maintain, provide and/or host network 21 consisting of at least transmitting device 20, receiving device 200, pendant device 400, and potentially an external system (not shown) via a discoverable signal. In one implementation, the external system may be a cloud-based system. Processor(s) 41 may be configured to communicate with receiving device 200, pendant device 400, and/or the external system via network 21 by exchanging signals (e.g., analog, digital, optical, and/or the like) through the communication component(s) 42 of transmitting device 20.

Processor(s) 41 may be configured to execute processor executable instructions stored on structured database 56 and/or execute program logic 58 such that when executed by processor(s) 41 causes processor(s) 41 to bi-directionally communicate to clock component(s) 49 thereby causing clock component(s) 49 begin measuring the passage of time. Examples of processor 41 may include, but are not limited to, a digital signal processor (DSP), a central processing unit (CPU), a field programmable gate array (FPGA), a microprocessor, a multi-core processor, combinations thereof and/or the like.

It should be noted network 21 may be a 900 MHz, 2.4 GHz, 3.6 GHz, 4.9 GHz, 5 GHz, 5.9 GHz, 6 GHz, and 60 GHz Wi-Fi/Bluetooth network (or any other frequency that Wi-Fi/Bluetooth evolve to) that may be implemented as the World Wide Web (or Internet), a low frequency network such as a LORA WAN, XBEE, a local rea network (LAN), a wide area network (WAN), a metropolitan network, a wireless network, a cellular network, a Global System for Mobile communications (GSM) network, a code division multiple access (CDMA) network, a 3G network, a 4G network, a 5G network, a satellite network, a radio network, an optical network, a cable network, an Ethernet network, combinations thereof, and/or the like. In one implementation, the outside network may also comprise a server system having multiple servers in a configuration suitable to provide a commercial computer-based business system such as a commercial website and/or data center.

Processor(s) 41 may be configured to execute processor executable instructions stored on structured database 56 and/or execute program logic 58 such that when executed by processor(s) 41 causes processor(s) 41 to bi-directionally communicate with indicator 47 so that indicator 47 provides and indication as to the state or condition of receiving device 400. The state or condition of transmitting device 20 may be the level of power within the power supply 45, the current version of processor executable instructions and/or code operating the receiver, the viability of network 21 generated between the transmitting device 20, receiving device 200, pendant device 400, and/or external system, the alignment of transmitting device 20 with receiving device 200 thereby establishing electronic gate 54 extending between the plurality of transmitters of transmitting device 20 and the plurality of receivers of receiving device 200, and the like.

The communication component 42 of transmitting device 20 may be configured to bi-directionally communicate via one or more wireless communication signal with receiving device 200, pendant device 400, and the like. In some non-limiting implementations, communication component 42 of transmitting device 20 may be configured to bi-directionally communicate via one or more wireless communication signals with an external system (not shown), such as a cloud-based network. In some non-limiting implementations, communication component 42 of transmitting device 20 may be configured to generate, establish, maintain, and/or host network 21 with receiving device 200, pendant device 400, or the like. In some non-limiting implementations, communication component 42 of transmitting device 20 may be configured to generate, establish, maintain, and/or host network 21 with receiving device 200, pendant device 400, or an external system (not shown). In one implementation, the external system may be a cloud-based system.

In some implementations, communication component 42 may be a data communication radio technology such as an IEEE 802.11 or that like. In some non-limiting components, communication component 42 may be an operator component such as an antenna, a Wi-Fi enabled device, Bluetooth enabled device, radio frequency enabled device, or the like. The antenna may be RF, Bluetooth, or the like. In other non-limiting components, communication component 42 may be a Wi-Fi enabled device, or the like. In some non-limiting implementations, the antenna may be positioned within transmitting member 22. In other non-limiting implementations, the antenna may be positioned on the one or more sidewall 31 of transmitting member 22. Communication component 42 may be lower frequency RF, longer range LORA WAN, XBEE, Thread, Bluetooth, Zigbee, or the like.

Port 43 of transmitting assembly 24 may be a connection interface configured to receive energy from an external electrical energy source. In some implementations, port 43 may be configured to receive processor executable instructions and/or code that may be used to update or replace the processor executable instructions and/or code stored within database 56 and program logic 58. Port 43 may be positioned within sidewall(s) 31 of transmitting device 20. Port 43 may be a USB port, a USB-C port, firewire, or the like.

Converter 44 of transmitting assembly 24 may be configured to receive unprocessed electrical energy from an electrical energy source through port 43 of transmitting assembly 24. Converter 44 may then convert the unprocessed electrical energy to processed electrical energy for output. Converter 44 may be supported by and positioned within transmitting member 22.

Power supply(ies) 45 of transmitting assembly 24 may be configured to receive energy from converter 44, store the received energy within power supply 45, and supply electrical energy to the components of transmitting assembly 24 of transmitting device 20. Power supply 45 may be supported by and positioned within transmitting member 22. In some non-limiting implementations, power supply 45 may be configured to be in a configuration of at least a portion of sidewall(s) 31 of transmitting member 22 of transmitting device 20. Power supply 45 may be a lithium-ion battery, a 9V battery, AA battery, alkaline battery, lead-acid battery, or the like. In some non-limiting implementations, power supply 45 may be a chargeable battery.

Powering member 46 of transmitting assembly 24 may be configured to power the components of transmitting assembly 24 thereby allowing for the flow of electrical energy to the components of transmitting assembly 24 of transmitting device 20. The powering member 46 may be positioned within the at least one sidewall 31 of transmitting member 22 of transmitting device 20 such that the components of transmitting assembly 24 may not be powered until powering member 46 is engaged by one or more users. A first engagement of powering member 46 by a user may turn transmitting device 20 “ON” such that the components of transmitting assembly 24 may receive power from power supply 45 when power supply 45 has stored power. A second engagement of powering member 46 by a user may turn transmitting device 20 “OFF” as such the components of transmitting assembly 24 may not receive power from power supply 45. In some non-limiting implementations, powering member 46 may be a power button or a power switch.

In some non-limiting implementations, transmitting assembly 24 may have indicator 47. Indicator 47 of transmitting assembly 24 may be supported by sidewall(s) 31 of transmitting member 22. Indicator 47 may be configured to provide information on the state or condition of transmitting device 20. The condition of transmitting device 20 may, for example, indicate the percentage of power remaining within power supply 45, the installed version of program logic, the installed version of processor executable code and/or information within one or more structured database 56. Indicator 47 may be in data communication with transmitting device 20, receiving device 200 and pendant device 400, the connectivity of transmitting device 20 to receiving device 200, pendant device 400, and an external system, and the like. Indicator 47 may be visual, auditory, haptic, and the like. Visual indicator 47 may also be a light such as an LED light or the like. The light may be different colors and/or various intensity of colors depending on the state or condition of transmitting device 20.

By way of example, but in no way limiting, the color of the visual indicator 47 may be red, orange, yellow, green, blue, indigo, violet, or the like. In some non-limiting implementations, multiple visual indicators 47 may provide information on a plurality of states or conditions of the transmitting device 20. For example, a multicolor LED indicator 47 may be configured to provide information on a plurality of states or conditions of transmitting device 20. In another non-limiting implementation, indicator 47 may include a haptic indicator, such as a vibration or pulse. In some implementations, indicator(s) 47 may include an output component (not shown). The output component may be a visual display such as a display screen, a graphical user interface, or the like. In another non-limiting implementations, indicator 47 may be included in a paired device. In some non-limiting implementations, indicator 47 may be configured to have an opening positioned within the indicator and powering member 46 may be positioned within the opening. In some non-limiting implementations, indicator 47 may operate in combination with powering member 46. By way of example, but in no way limiting, indicator 47 operating in combination with powering member 46 may be an LED power button.

Digital amplifier component 48 of transmitting assembly 24 may be configured to increase the frequency of the infrared wavelength of output light signal 52 transmitted by transmitter 38. In some non-limiting implementations, digital amplifier component 48 may increase the intensity of the light emitted from light source 50 of transmitter 38.

As illustrated in FIGS. 1 and 2, support assemblies 26 of transmitting device 20 may have at least one member 60 and a positioning member 62. In some non-limiting implementations, each of support assemblies 26 may have a connecting member 64 and a bracing member 66. Support assemblies 26 of transmitting device 20 may be configured to support and position transmitting member 22 at a height or height range above the surface S of the ground and to orient transmitting member 22 substantially perpendicular to surface S. In some non-limiting implementations, support assemblies 26 may be configured to extend approximately 34 inches above surface S. In other non-limiting implementations, support assemblies 26 may be configured as a tripod having a first member 60a, a second member 60b, a third member 60c, connecting member 64, and bracing member 66 (see FIG. 2).

Each of members 60 of support assembly 26 has a first end 67, a second end 68, and at least one sidewall 69 extending from first end 67 to second end 68. In some non-limiting implementations, first end 67 of one member 60 may have an opening extending through first end 67 of member 60 (not shown). In some implementations, second end 68 of member 60 may have an angle of insertion A configured position in second end 68 of member 60 of support assembly 26 below a surface S at a predetermined location as can be seen in FIG. 1. In some implementations, support assembly 26 of transmitting device 20 may have a plurality of members 60. Each of member 60 of support assembly 26 may have a length of approximately 1 inch to 50 inches. Members 60 of support assembly 26 may be constructed of metal, plastic, or the like provided that members 60 are capable of providing structural support to transmitting assembly 22.

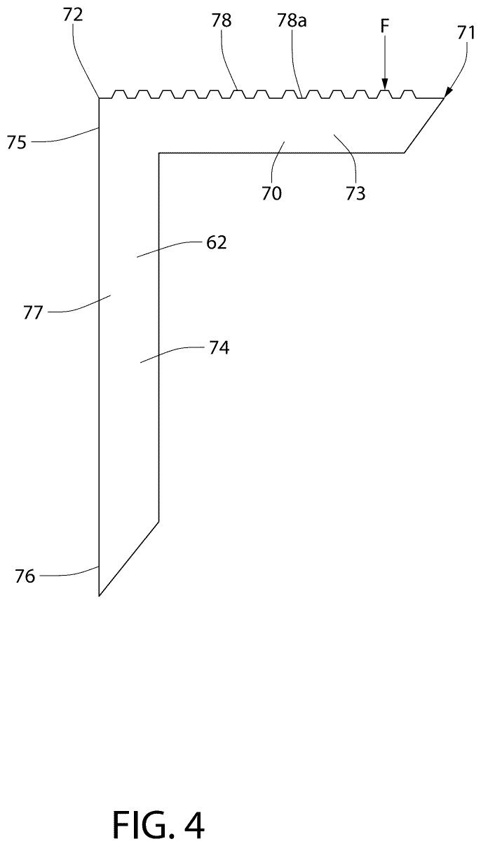

FIG. 4 discloses an exemplary positioning member 62 of support assembly 26 in accordance with the present disclosure. Positioning member 62 of support assembly 26 may have a first segment 70 having a first end 71, a second end 72, and an intermediate portion 73 extending from first end 71 to second end 72. Positioning member 62 may be positioned on at least one sidewall 69 of a member 60 of support assembly 26. In one implementation, first end 71 of first segment 70 of positioning member 62 may be connected to and extending away from a sidewall 69 of a member 60 of support assembly 26. In some implementations, positioning member 62, may have a second segment 74 having a first end 75, a second end 76, and an intermediate portion 77 extending from first end 75 to second end 76.

In some non-limiting implementations, first end 75 of second segment 74 may connected to second end 72 of the first segment 70 and second end 76 of second segment 74 may be connected to a sidewall 69 of a member 60 of support assembly 26. In some implementations, a top surface 78 of first segment 70 of positioning member 62 may have one or more traction members 78a. Traction members 78a may be at least one groove configured into top surface 77 of first segment 70 of positioning member 62. In other non-limiting implementations, traction members 78a may be positioned on top surface 78 of first segment 70 of positioning member 62. By way of example, but in no way limiting, traction member 78 may be a strip of rubber, plastic, or the like. Positioning member 62 may be rubber, metal, plastic, or the like.

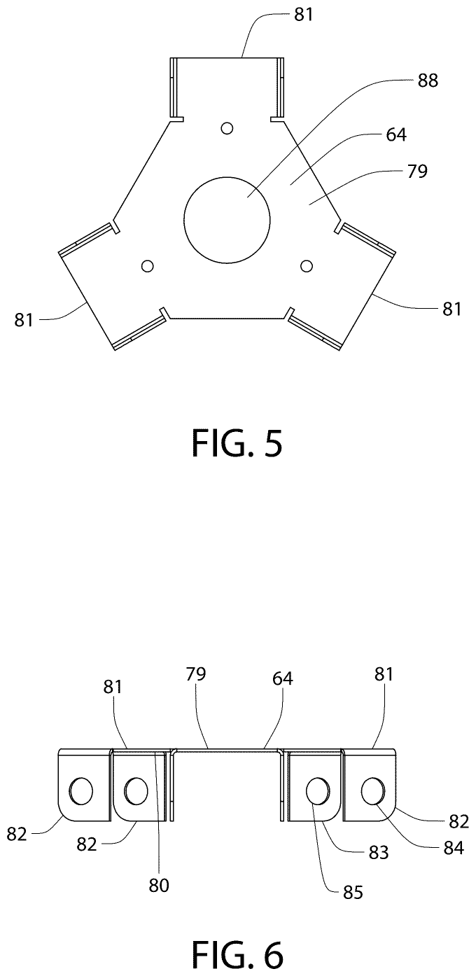

FIG. 5 is a top plan view of an exemplary connecting member 64 in accordance with the present disclosure. Connecting member 64 of support assembly 26 may have top surface 79, a bottom surface 80 positioned opposite the top surface 79, and a plurality of connecting ends 81. In some non-limiting implementations, connecting member 64 may have an opening 88 positioned substantially in the center of connecting member 64.

FIG. 6 illustrates a side plan view of connecting member 64. The plurality of connecting ends 81 of connecting member 64 may have a first wall 82 extending substantially perpendicular from bottom surface 80 of connecting member 64 and a second wall 83 extending substantially perpendicular from bottom surface 80 of connecting member 64 and positioned opposite first wall 82. First wall 82 of connecting end 81 may have an opening 84. Second wall 83 of connecting end 81 may have an opening 85 such that opening 85 of second wall 83 is substantially aligned with opening 84 of first wall 82. In some non-limiting implementations, connecting end 81 of connecting member 64 may be configured to moveably connect to first end 67 of member 60 of support assembly 26 via one or more fasteners 86 being positioned in and extending through opening 84 of first wall 82, the opening (not shown) of first end 67 of member 60 of support assembly 26, and opening 85 of second wall 83 of connecting member 64 (See FIG. 2). Fasteners 86 may be a screw, a pin, nail or the like.

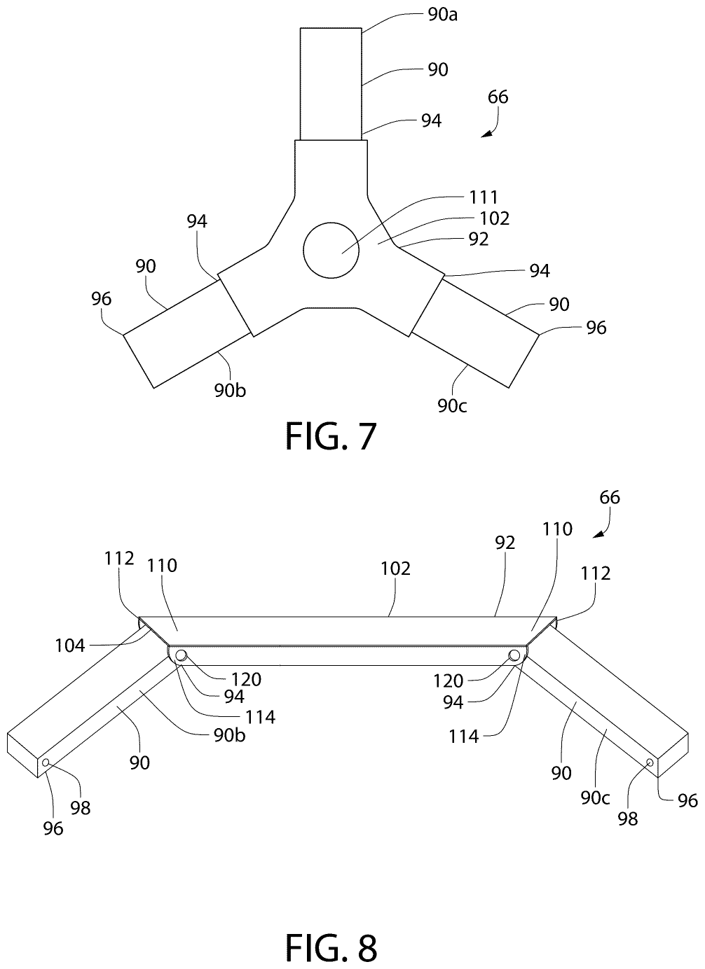

FIG. 7 is a top plan view of bracing member 66 of support assembly 26. As can be seen in FIGS. 7-8, bracing member 66 of support assembly 26 may have a plurality of extending members 90 and a second connecting member 92. Bracing member 66 may be configured to be moveable between a first contracted position, a second expanded position, and an intermediate position between the first contracted position and the second expanded position. Bracing member 66 may be manufactured from metal, plastic, or the like. In some non-limiting implementations, support assembly 26 in the second expanded position may have a circumference of approximately 44 inches. In some non-limiting implementations, the second expanded position may have a diameter of approximately 1 inch to approximately 60 inches.

The plurality of extending members 90 of bracing member 66 may have a first end 94 and a second end 96 positioned opposite first end 94. First end 94 of extending member 90 may have an opening (not shown) extending through first end 94 of the extending member 90. Second end 96 of extending member 90 may have an opening 98 extending through second end 96 of extending member 90.

FIG. 8 illustrates a perspective side view of bracing member 66 having the plurality of extending members 90 and second connecting member 92. Second connecting member 92 of bracing member 66 may have top surface 102, a bottom surface 104 positioned opposite top surface 102, and a plurality of connecting ends 110. In some non-limiting implementations, second connecting member 92 may have an opening 111 positioned substantially in the center of second connecting member 92. The plurality of connecting ends 110 of connecting member 92 may have a first wall 112 extending substantially perpendicular from bottom surface 104 of connecting member 92 and a second wall 114 extending substantially perpendicular from bottom surface 104 of connecting member 92 and positioned opposite first wall 112. First wall 112 of connecting end 110 may have an opening (not shown). Second wall 114 of connecting end 110 may have an opening 120 such that opening 120 of second wall 114 is substantially aligned with the opening of first wall 112. In some non-limiting implementations, connecting end 110 of a second connecting member 92 may be configured to moveably connect to first end 94 of one of the plurality of extending members 90 via fastener 86 being positioned in and extending through the opening of first wall 112, the opening of first end 94 of one of the plurality of extending members 90, opening 120 of second wall 114 of second connecting member 92 (see FIG. 8). Second connecting member 92 may be manufactured from metal, plastic, or the like.

In some non-limiting implementations, second end 96 of extending member 90 may be moveably connected to at least one member 60 of support assembly 26. By way of example, but in no way limiting, sidewalls 69 of member 60 of support assembly 26 may be configured to have a channel 130 having a first side 132 and a second side 134. First side 132 of channel 130 of member 60 of support assembly 26 may have an opening 136. The second side 134 of the channel 130 of the one or more member 60 of the support assembly 26 may have an opening 138 substantially aligned with opening 136 of first side 132 of channel 130. As an be seen in FIG. 2, second end 92 of extending member 90 may be moveably connected to member 60 of support assembly via positioning second end 92 of extending member 90 within channel 130 of member 60 of support assembly 26 such that opening 136 of first side 132 of channel 130, opening 98 of second end 96 of extending member 90, and opening 138 of second side 134 of channel 130 may be substantially aligned and positioning fastener 86 within and extending through opening 136 of first side 132 of channel 130, opening 98 of second end 92 of extending member 90, and opening 138 of second side 134 of channel 130.

In some non-limiting implementations, a first extending member 90a of bracing member 66 is connected to a first member 60a of support assembly 26 and a second extending member 90b is connected to a second member 60b of support assembly 26 such that bracing member 66 is positioned between first member 60a and second member 60b of the plurality of members 60. In some non-limiting implementations, bracing member 66 may have a third extending member 90c connected to a third member 60c of support assembly 26.

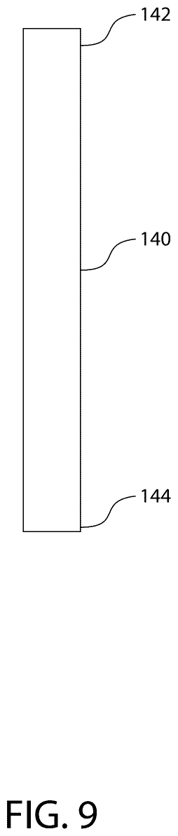

In some non-limiting implementations, support assembly 26 may have a reinforcing member 140 (see FIG. 9) that may be removably positioned between connecting member 64 and second connecting member 92. Reinforcing member 140 may have a first end 142 and a second end 144. First end 142 of reinforcing member 140 may be positioned within opening 88 of connecting member 64 and second end 144 of reinforcing member 140 may be positioned within the opening of second connecting member 92 when bracing member 66 of support assembly 26 is in the second expanded position or an intermediate position between the first contracted position and the second expanded position.

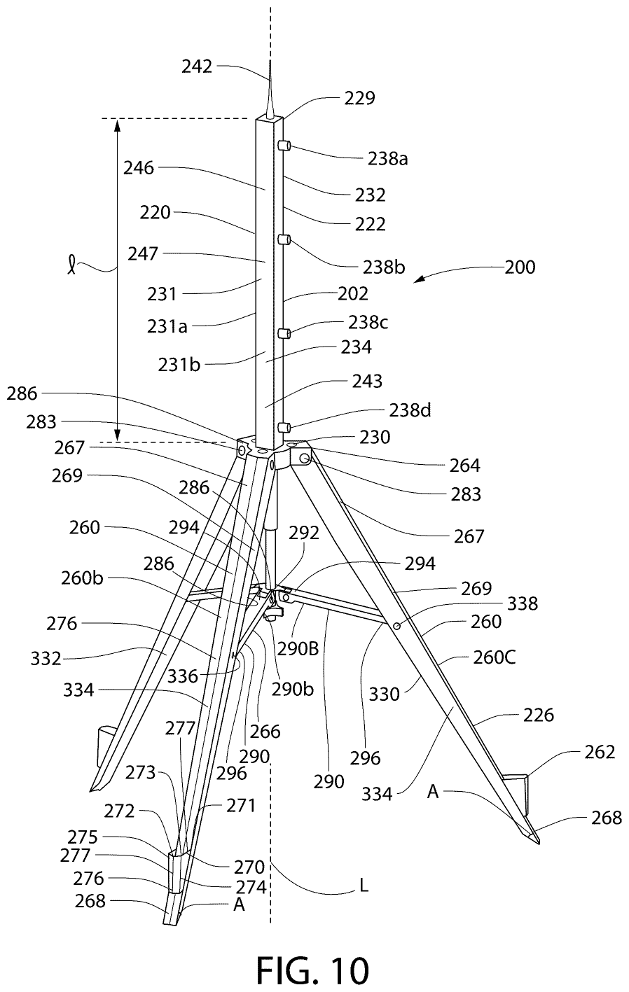

In a similar manner, as can be seen in FIG. 10, receiving device 200 may have receiving member 202, receiving assembly 204 positioned within receiving member 202, and support assembly 206. Receiving device 200 may be configured to receive at least one of the output light signals from t transmitters 38 of transmitting device 20 in order to determine time intervals.

Receiving member 202 of receiving device 200 may have a first end 229, a second end 230, and at least one sidewall 231 extending form the first end 229 to the second end 230, such that sidewall 231 defines a bore (not shown) extending from first end 229 to second end 230 of receiving member 202. The bore may extend from first end 229 to second end 230 of receiving member 202 and may be defined by an internal surface sidewall 231 that extends between first end 229 and second end 230. The bore may have a first portion 232 and a second portion 234. First portion 232 of the bore of receiving member 202 may be positioned adjacent first end 229 of receiving member 202. Second portion 234 of the bore of receiving member 202 may be positioned adjacent second end 230 of receiving member 202.

In some implementations, receiving member 202 may have a length 1 extending from first end 229 to second end 230 of receiving member 202. In some implementations, receiving member 202 may have a first sidewall 231a and a second sidewall 231b. First sidewall 231a of receiving member 202 may be connected to second sidewall 231b of receiving member 202 by a fastener as described above. The fastener may be a screw, pin, nail, or the like. Sidewall 231 of receiving member 202 may be metal, plastic, or the like.

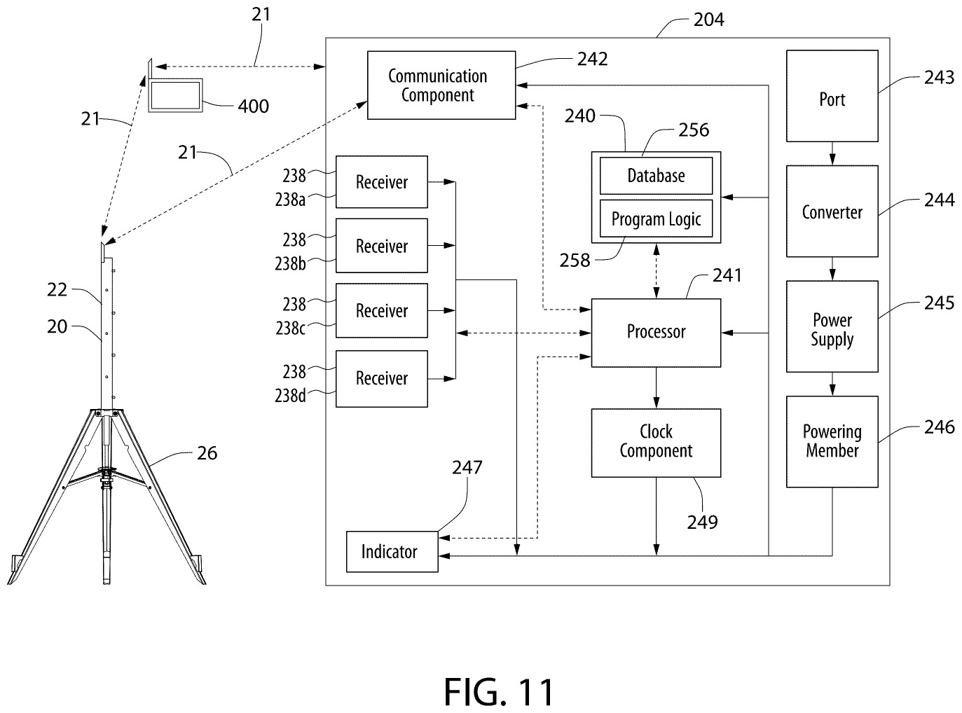

As illustrated in FIG. 11, receiving assembly 204 of the receiving device 200 may have at least one receiver 238 supported by sidewall(s) 231 of receiving member 202, one or more non-transitory computer-readable storage medium 240, processor(s) 241, a communication component 242, a port 243, a converter 244, one or more power supply 245, and powering member 246 positioned within receiving member 202 of receiving device 202. In some non-limiting implementations, receiving assembly 204 may also utilize indicator 247. In some non-limiting implementations, receiving assembly 204 may have a clock component 249. Clock component 249 may be configured to provide inputs in the determination of the passage of time. In some non-limiting implementations, receiving device 200 may have a power management unit (not shown) having a port 243, power supply(ies) 245, and powering member 246. The power management sub-system may be configured to output power to the components of receiving assembly 224. Receiving assembly 204 may be positioned within the bore of receiving member 202 such that receivers 238 of receiving assembly 224 are positioned between a height of approximately 36 inches and approximately 56 inches above the surface.

Receivers 238 of receiving assembly 204 may be supported by sidewalls 231 of receiving member 202. Receivers 238 may include detectors and/or other circuitry that is capable of detecting light signals. In particular, receivers 238 may be configured to receive output light signals 52 from transmitters 38. In other implementations, receiving assembly 204 may have a plurality of receivers 238a, 238b, 238c, 238d, . . . 238n. The reference number 238a, 238b, 238c, . . . 238n may be used interchangeably with the reference number 238. As illustrated, receiving assembly 204 of receiving device 200 has four receivers 238a-d; however, the number of receivers 238 may vary as needed (in a manner similar to that described above with respect to the light transmitters). By way of example, but in no way limiting, receiving assembly 204 may have two receivers 238 or up to ten or more receivers 238. In cases where receiving assembly 204 has multiple receivers 238, each receiver 238 of multiple receivers 238 may be configured to receive different frequencies of output signals signal 52 from transmitters 38 of the transmitting device 202. Alternatively, receivers 238 may be similar to each other and configured to receive substantially similar frequencies of output light signals 52 from transmitters 38 of transmitting device 20. Receivers 238 of receiving assembly 204 may be configured to receive a plurality of output light signals 52 transmitted by the transmitters 38a-d of transmitting device 204 as discussed below.

By way of example, but in no way limiting, a first receiver 238a of receiving assembly 204 may be positioned a first distance D1 from a surface S. In a preferred implementation, first transmitter 38a may be positioned approximately 56 inches from the surface. Subsequently arranged receivers 238b, 238c, etc., may be spaced apart from each other a second distance D2 (i.e., an intra-transmitter distance D2). Second distance D2 may be consistent for receivers 238 disposed within and supported by sidewalls 231 of receiving member 202. In some implementations, last receiver 238n of receiving assembly 204 may be positioned a distance D3 from the surface (illustrated as receiver 238d in FIG. 1).

In a preferred implementation, the last receiver 238n may be positioned approximately 36 inches from the surface S. The positioning of receivers 238 within sidewalls 231 of receiving member 202 may be configured to selectively receive output light signals 52 from each of transmitters 38 thereby generating an electronic gate 54 as described above (see, for example, FIG. 24). In some non-limiting implementations, receivers 238 may be configured to receive light signals 52 transmitted from transmitters 38 such that the communication of light signal 52 from transmitters 38 may be as a sequence. The sequence of transmission of the first signal 52a communicated by the first transmitter 52 to the last signal 52n communicated by the last transmitter 52n may be for a period of time. The period of time of the sequence may be between approximately 1 millisecond to approximately 600 milliseconds. In some non-limiting implementations, the period of time of the sequence may be approximately 2 milliseconds. In other non-limiting implementations, the transmitting assembly may have one or more FPGA chip that may be configured to have the sequence be a period of time of approximately 0.1 milliseconds. The transmissions from transmitters 38 to receivers 238 may be performed in serial such that signal 52a is transmitted and then transmitter 38a ceases transmission. Upon transmitter 38a ceasing transmission, transmitter 38b begins transmission, etc., until each transmitter has transmitted its signal. Then the process begins again with transmitter 38a.

The one or more non-transitory computer-readable storage medium 240; i.e., non-transitory memory, of receiving assembly 204 of receiving device 200 may have structured database(s) 256 and program logic 258 (see FIG. 11). The non-transitory computer-readable storage medium 240 may be configured to store processor executable code and/or information within structured database(s) 256 and program logic 258.

Structured database(s) 256 of the non-transitory computer-readable storage medium 240 may be a database, a data table, or the like. Structured database 256 may include processor executable instructions and/or code capable of being executed by processor(s) 241, that when executed by processor(s) 241 causes the processor(s) to execute the commands programmed within the instructions and/or code. The processor executable instructions and/or code may be in the form of software and/or firmware, written in any suitable programming language.

Program logic 258 of non-transitory computer-readable storage medium 240 may have processor executable instructions and/or code, which when executed by processor 241, may cause processor 241 to execute the commands programmed within the instructions and/or code. In some implementations, program logic 258 may be executed for receiving device 200 by processor 241 and/or program logic 258 may be executed by processor 241 in a networked environment including, but not limited to, transmitting device 20, receiving device 200, and pendant device 400. The processor executable instructions and/or code may be in the form of software and/or firmware, written in any suitable programming language. Suitable programming language may be C, C++, Python, Java, JavaScript, SQL, and the like.

Processor 241 of transmitting assembly 204 may be a single unit processor, separate processors, multi-core processor, including, but not limited to microprocessors working together or independently to, execute processor executable instructions and/or code stored on structured database 256 and/or program logic 258 described herein. Processor 241 may be configured to communicate with receiver 238, non-transitory computer readable medium 240, communication component 242, and/or indicator 247 via one or more paths. Processor 241 may be configured to read and/or execute processor executable instructions and/or code. Processor 241 may also be configured to create, manipulate, alter, and/or store data structures within non-transitory computer-readable storage medium 240 of receiving assembly 204.

Processor 241 may be configured to execute processor executable instructions stored on structured database 256 and/or execute program logic 258 such that when executed by processor 241 causes processor 241 to bi-directionally communicate with receivers 238 to determine a state of electronic gate 54 of system 10. The state of electronic gate 54 may be a first armed state, a second armed state, a first unarmed state, and a second unarmed state. Processor 241 may be configured to execute processor executable instructions stored on structured database 256 and/or execute program logic 258 such that when executed by processor 241 to bi-directionally communicate with communication component 242 to generate, maintain, provide, and/or host network 21 consisting of transmitting device 20, receiving device 200, and pendant device 400 via a discoverable signal. Once processor 241 detects discoverable signals from each of transmitting device 20, receiving device 200 and pendant device 400, processor 241 can establish a closed wireless network of just those three devices, or the network can be configured such that a mobile device may join the network using a dedicated app or browser webpage.

Pendant device 400 receives time interval messages from receiving device 200 and can provide the determined timing intervals to a display, such as a scoreboard at the event. Alternately, a network may be established with a series of transmitting device/receiving device pairs when it is desired to determine split time intervals, in which case the device pairs would be configured in a closed network with a single pendant device 400.

Processor(s) 241 may be configured to execute processor executable instructions stored on structured database 256 and/or execute program logic 258 such that when executed by processor(s) 241 to communicate with transmitting device 20 and/or pendant device 400 of the system 10 via wireless signals (e.g., analog, digital, or the like). In some non-limiting implementations, processor(s) 241 may be configured to execute processor executable instructions stored on structured database 256 and/or execute program logic 258 such that when executed by processor(s) 241 causes processor(s) 241 to bi-directionally communicate data with the communication component 242 in order to generate, maintain, provide and/or host network 21 consisting of transmitting device 20, receiving device 200, and pendant device 400. In addition, access to network 21 by a mobile device running a dedicated app and/or via a browser webpage may also be permitted. The app, for example, might provide a user with the capability to configure the system and/or to check on historical time interval data, etc. In one implementation, an outside network may also be granted access, the outside network may include a server system having multiple servers in a configuration suitable to provide a commercial computer-based business system such as a commercial website and/or data center.

Processor(s) 241 may be configured to communicate with transmitting device 20, receiving device 200, pendant device 400, and/or the external system via network 21 by exchanging data signals (e.g., analog, digital, optical, and/or the like) through communication component 242 of receiving device 200. Processor 241 may be configured to execute processor executable instructions stored on structured database 256 and/or execute program logic 258 such that when executed by processor(s) 241 causes processor(s) 241 to bi-directionally communicate to clock component 249 thereby causing clock component 249 to begin measuring the passage of time. Examples of processor(s) 241 may include, but are not limited to, a digital signal processor (DSP), a central processing unit (CPU), a field programmable gate array (FPGA), a microprocessor, a multi-core processor, combinations thereof and/or the like.

It should be noted the network 21 may be a 900 MHz, 2.4 GHz, 3.6 GHz, 4.9 GHz, 5 GHz, 5.9 GHz, 6 GHz, and 60 GHz Wi-Fi/Bluetooth network that may be implemented as the World Wide Web (or Internet), a low frequency network such as a LORA WAN, XBEE, a local rea network (LAN), a wide area network (WAN), a metropolitan network, a wireless network, a cellular network, a Global System for Mobile communications (GSM) network, a code division multiple access (CDMA) network, a 3G network, a 4G network, a 5G network, a satellite network, a radio network, an optical network, a cable network, an Ethernet network, combinations thereof, and/or the like. Processor 241 may be configured to execute processor executable instructions stored on structured database 256 and/or execute program logic 258 such that when executed by processor(s) 241 causes processor(s) 241 to bi-directionally communicate with indicator 247 to indicate specific information as to the state or condition of receiving device 200. The state or condition of receiving device 200 may, for example, be the percentage of battery power remaining within power supply 245, the current version of processor executable instructions and/or code operating the receiver, the viability and/or reliability of network 21 generated between transmitting device 20, receiving device 200, pendant device 400, and/or optional external system connections and/or mobile device connections as described above.

Alignment of the transmitters 38 of transmitting device 20 with receivers 238 of receiving device 200 may be used to establish electronic gate 54. Timing for an event begins when the participant passes through electronic gate 54 (or light curtain as referred to herein above) and ends when the participant passes through electronic gate 54 a second time. In particular, when the participant passes through the electronic gate the first time, the system waits a predetermined amount of time before resetting the gate to ensure that the participant has completely exited the gate. The electronic gate then resets to a condition similar to that shown in FIGS. 23A-23D and FIG. 24 and waits for the event to complete by the participant crossing electronic gate 54 a second time.

Communication component 242 of receiving device 200 may be configured to bi-directionally communicate via one or more wireless communication signal with transmitting device 20, receiving device 200, and pendant device 400, as described above. Communication component 242 of receiving device 200 may be configured to generate, establish, maintain, and/or host network 21 with the transmitting device 20 and pendant device 400 such that the three devices are formed into a three node closed network, wherein transmitting device 20 is a node on network 21, receiving device 200 is a node on network 21, and pendant device 400 is a node on network 21.

In some implementations, communication component 242 may utilize a data communication radio technology such as an IEEE 802.11 or the like. In some non-limiting components, communication component 242 may be an operator device such as an antenna, a Wi-Fi enabled device, Bluetooth enabled device, radio frequency enabled device, or the like. The antenna may be RF, Bluetooth, or the like. In some non-limiting implementations, the antenna may be positioned within receiving member 202. In other non-limiting implementations, the antenna may be positioned on one of sidewalls 231 of receiving member 202. In other non-limiting components, communication component 242 may utilize lower frequency RF, longer range LORA WAN, XBEE, Thread, Bluetooth, Zigbee, or the like.

In other non-limiting components, communication component 242 may include Wi-Fi enabled circuitry, or the like. Communication component 242 may also utilize lower frequency RF, longer range LORA WAN, XBEE, Thread, Bluetooth, Zigbee, or the like.

Port 243 of receiving assembly 204 may be a connection interface configured to receive energy from an external electrical energy source (such as, for example, a wall outlet via a cord or an external battery). In some implementations, port 243 may be configured to receive processor executable instructions and/or code that may be used to update or replace the processor executable instructions and/or code stored within database 256 and program logic 258. Port 243 may be positioned within sidewall 231 of receiving member 200. The port may be a USB-A port, a USB-C port, micro-USB, mini-USB, or similar data connection point.

Converter 244 of receiving assembly 204 may be configured to receive unprocessed electrical energy from an electrical energy source through port 243 of receiving assembly 204. Converter 244 may then convert the unprocessed electrical energy to processed electrical energy for output. Converter 244 may be supported by and positioned within receiving member 202.

Power supply 245 of receiving assembly 204 may be configured to receive energy from the converter, store the received energy within power supply 245 (such as in a conventional battery, not shown), and supply electrical energy to the components of receiving assembly 204 of receiving device 202. Power supply 245 may be supported by and positioned within receiving member 202 of receiving device 200. In some non-limiting implementations, power supply 245 may be configured to physically fit within one or more sidewalls 231 of receiving member 202 of receiving device 200. Power supply 245 may, for example, include lithium-ion batteries, 9-volt batteries, conventional batteries, alkaline batteries, lithium batteries, lead-acid batteries, etc. In some implementations, power supply 245 may be a chargeable battery.

Powering member 246 of receiving assembly 204 may be configured to power the components of receiving assembly 204 by allowing for the flow of electrical energy to the components of receiving assembly 204 of receiving device 200. Powering member 246 may be positioned within sidewalls 231 of receiving member 200 of receiving device 200 such that the components may not be powered until the powering member is engaged by one or more users. A first engagement of powering member 246 by a user may turn the receiving device 200 “ON” such that the components of receiving assembly 204 may receive power from power supply 245 when power supply 245 has stored power. A second engagement of powering member 246 by a user may turn the receiving device 200 “OFF” as such the components of receiving assembly 204 would then not receive power from power supply 245. In some non-limiting implementations, powering member 246 may be a power button or a power switch.

In some non-limiting implementations, receiving assembly 204 may have an indicator 247. Indicator 247 of receiving assembly 204 may be supported by sidewalls 231 of receiving member 202. Indicator 247 may be configured to provide information on the state or condition of receiving device 200. The state or condition of receiving device 200 may be the amount of power stored within power supply 245, the installed version of program logic 258, connectivity of receiving device 200 to transmitting device 20 and the pendant device 400, and the connectivity of receiving device 200 to transmitting device 20, pendant device 400, and an external system, and the like.

Indicator 247 may be visual, auditory, haptic, and the like. Indicator 47 may be visual such as a light like an LED light or colored indicator light bulbs. The status light may be different colors and/or various intensity of colors depending on the state or condition of receiving device 200. By way of example, but in no way limiting, the color of visual indicator 247 may be red, orange, yellow, green, blue, indigo, violet, or the like. In some non-limiting implementations, multiple visual indicators 247 may provide information on a plurality of states or conditions of receiving device 200. For example, a multicolor LED indicator 247 may be configured to provide information on a plurality of states or conditions of receiving device 200. In another non-limiting implementation, indicator 247 may include a haptic feedback, such as a vibration or pulse. In some implementations, indicator 247 may include an output component (not shown). The output component may include a display screen (or send status information to a display screen), a graphical user interface, or the like. In another non-limiting implementations, indicator 247 may be included in a paired device.

In some non-limiting implementations, indicator 247 may be configured to have an opening positioned within the indicator and powering member 246 may be located within that opening. In some non-limiting implementations, indicator 247 may operate in combination with powering member 246. By way of example, but in no way limiting, indicator 247 in combination with powering member 246 may be an LED power button that both may be operated to turn the system “ON” and “OFF” as well as provide multi-colored status indicator lighting.

As illustrated in FIGS. 1 and 10, support assemblies 206 of receiving device 200 may have members 260 and positioning members 262. In some non-limiting implementations, support assemblies 206 may utilize connecting members 264 and bracing members 266 for additional structural integrity. Support assembly 206 of receiving device 200 may be configured to support and position receiving member 200 at a height or height range above surface S and to orient the receiving member 202 substantially perpendicular to surface S. In some non-limiting implementations, support assembly 206 may be configured as a tripod having a first member 260a, a second member 260b, a third member 260c, connecting member 264, and bracing members 266 (see, e.g., FIG. 10).

Members 260 of support assembly 206 each have a first end 267, a second end 268, and at least one sidewall 269 extending from first end 267 to second end 268. In some non-limiting implementations, first end 267 of members 260 may have an opening extending therethrough (not shown). In some implementations, second end 268 of members 260 may permit an angle of insertion A configured position for member 260 of support assembly 206 below a surface S where the legs of the tripod are installed at least in part into the ground for increased stability as shown in FIG. 1. Members 260 of support assembly 206 may have a length of approximately 1 inch to 50 inches. Members 260 of support assembly 206 may be manufactured from metal, plastic, or the like provided the members are capable of providing a stable platform for receiver device 200.

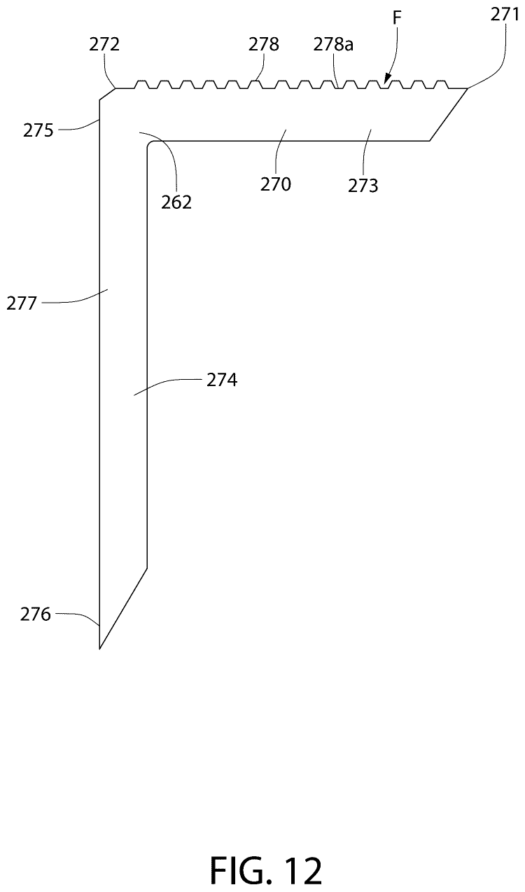

FIG. 12 discloses a side plan view of an exemplary positioning member 262 of support assembly 206 in accordance with the present disclosure. Positioning member 262 of support assembly 206 may have a first segment 270 having a first end 271, a second end 272, and an intermediate portion 273 extending from first end 271 to second end 272. Positioning member 262 may be positioned on at least one sidewall 269 of member 260 of support assembly 206. In one implementation, first end 271 of first segment 270 of positioning member 262 may be connected to and extending away from sidewall 269 of member 260 of support assembly 206. In some implementations, positioning member 262, may have a second segment 274 having a first end 275, a second end 276, and an intermediate portion 277 extending from the first end 275 to the second end 276. In some non-limiting implementations, first end 275 of second segment 274 may be connected to second end 272 of first segment 270 and second end 276 of second segment 274 may be connected to sidewall 269 of member 260 of support assembly 206. In some implementations, a top surface 278 of the first segment 270 of the positioning member 262 may have one or more traction member 278a. Traction member 278a may be at least one groove configured into the top surface 278 of first segment 270 of positioning member 262. In other non-limiting implementations, traction member 278a may be positioned on top surface 278 of first segment 270 of positioning member 262. By way of example, but in no way limiting, traction member 278a may be a strip of rubber, plastic, or the like. Positioning member 62 may be rubber, metal, plastic, or the like.

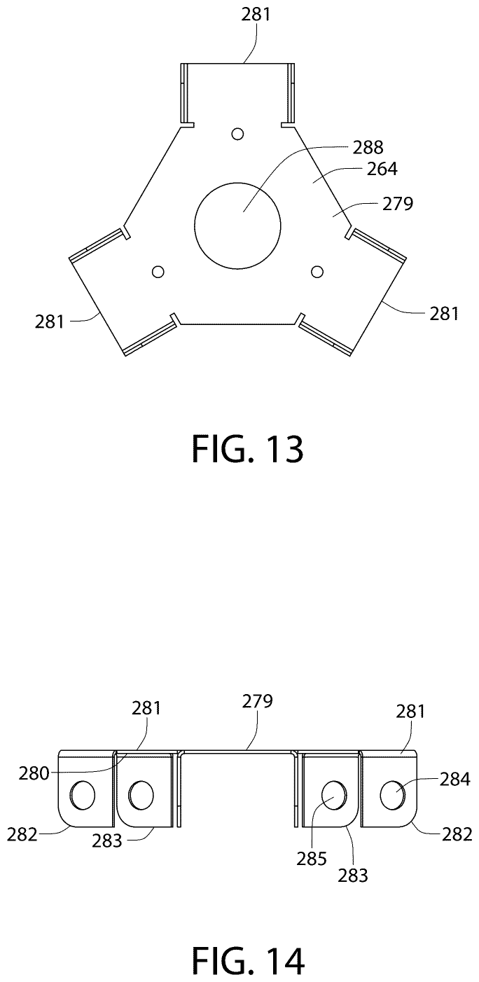

FIG. 13 is a top plan view of an exemplary connecting member 264 of support assembly 206 of receiving device 200 in accordance with the present disclosure. Connecting member 264 of support assembly 206 may have top surface 279, bottom surface 280 opposite top surface 279, and a plurality of connecting ends 281. In some non-limiting implementations, connecting member 264 may have an opening 288 positioned substantially in the center of the connecting member 264.

FIG. 14 illustrates a side plan view of connecting member 264. The plurality of connecting ends 281 of connecting member 264 may have a first wall 282 extending substantially perpendicular from the bottom surface 280 of connecting member 264 and a second wall 283 extending substantially perpendicular from bottom surface 280 of connecting member 264 and positioned opposite first wall 282. First wall 282 of connecting end 281 may have an opening 284. Second wall 283 of connecting end 281 may have an opening 285 such that opening 285 of second wall 283 is substantially aligned with opening 284 of first wall 282. In some non-limiting implementations, connecting end 281 of connecting member 264 may be configured to be moveably connected to first end 267 of member 260 of support assembly 206 via fastener 286 being positioned in and extending through opening 284 of first wall 282, the opening (not shown) of first end 267 of member 260 of support assembly 206, and opening 285 of second wall 283 of connecting member 264 (see, e.g., FIG. 2). Fastener 286 may be a screw, a pin, nail, or the like.

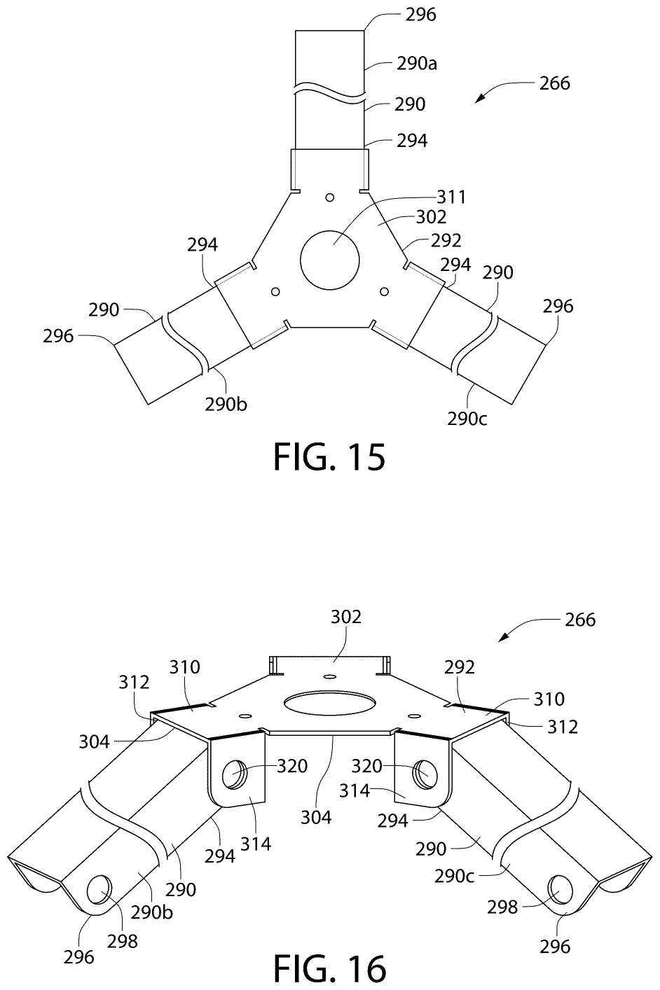

FIG. 15 is a top plan view of bracing member 266 of support assembly 206. As seen in FIGS. 15-16, bracing member 266 of support assembly 206 may have a plurality of extending members 290 and a second connecting member 292. Bracing member 266 may be configured to be moveable between a first contracted position, a second expanded position, and an intermediate position between a first contracted position and a second expanded position. Bracing member 266 may be manufactured from metal, plastic, or the like. In some non-limiting implementations, support assembly 206 in the second expanded position may have a circumference of approximately 44 inches. In some non-limiting implementations, the second expanded position may have a diameter of approximately 1 inch to approximately 60 inches.

The plurality of extending members 290 of bracing member 266 may have a first end 294 and a second end 296 positioned opposite first end 294. First end 294 of extending member 290 may have an opening (not shown) extending through first end 294 of extending member 290. Second end 296 of extending member 290 may have an opening 298 extending through second end 296 of extending member 290.

FIG. 16 illustrates a perspective side view of bracing member 266 having the plurality of extending members 290 and second connecting member 292. Second connecting member 292 of bracing member 266 may have top surface 302, a bottom surface 304 positioned opposite top surface 302, and a plurality of connecting ends 310. In some non-limiting implementations, second connecting member 292 may have an opening 311 positioned substantially center second connecting member 292. The plurality of connecting ends 310 of connecting member 292 may have a first wall 312 extending substantially perpendicular from the bottom surface 304 of the connecting member 292 and a second wall 314 extending substantially perpendicular from bottom surface 304 of connecting member 292 and positioned opposite first wall 312. First wall 312 of connecting end 310 may have an opening (not shown). Second wall 314 of connecting end 310 may have an opening 320 such that opening 320 of second wall 314 is substantially aligned with the opening of first wall 312.

In some non-limiting implementations, connecting end 310 of second connecting member 292 may be configured to moveably connect to first end 294 of one of the plurality of extending members 290 via fastener 286 being positioned in and extending through the opening of first wall 312, the opening of first end 294 of one of the plurality of extending members 290, the opening 320 of second wall 314 of second connecting member 292 (see FIG. 16). Second connecting member 292 may be manufactured from metal, plastic, or the like.

In some non-limiting implementations, second end 296 of extending member 290 may be moveably connected to member 260 of support assembly 206. By way of example, but in no way limiting, sidewall 269 of member 260 of support assembly 206 may be configured to have a channel 330 having a first side 332 and a second side 334. First side 332 of channel 330 of member 260 of support assembly 206 may have an opening 336. Second side 334 of channel 330 of member 260 of support assembly 206 may have an opening 338 substantially aligned with opening 336 of first side 332 of channel 330.

As seen in FIG. 10, second end 292 of extending member 290 may be moveably connected to member 260 of support assembly 206 via positioning second end 292 of extending member 290 within channel 330 of member 260 of support assembly 206 such that opening 336 of first side 332 of channel 330, opening 298 of second end 296 of extending member 290, and opening 338 of second side 334 of channel 330 may be substantially aligned and in position such that fastener 286 within and extending through opening 336 of first side 332 of channel 330, opening 298 of second end 292 of extending member 290, and opening 338 of second side 334 of channel 330.

In some non-limiting implementations, a first extending member 290a of bracing member 266 is connected to a first member 260a of support assembly 206 and a second extending member 290b is connected to second member 260b of support assembly 206 such that bracing member 266 is positioned between first member 260a and second member 260b of members 260. In some non-limiting implementations, bracing member 266 may have a third extending member 290c connected to a third member 260c of support assembly 206. Bracing member 266 may be metal, plastic, or the like.

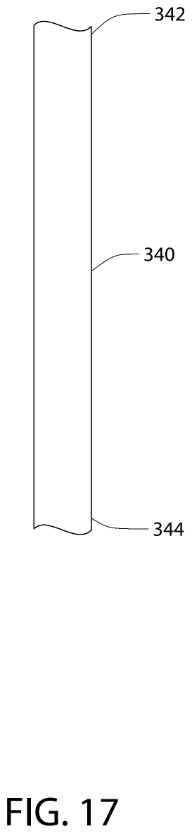

In some non-limiting implementations, support assembly 206 may have a reinforcing member 340 (see FIG. 17) that may be removably positioned between connecting member 264 and second connecting member 292. Reinforcing member 340 may have a first end 342 and a second end 344. First end 342 of reinforcing member 340 may be positioned within opening 288 of connecting member 264 and second end 344 of reinforcing member 340 may be positioned within opening 311 of second connecting member 292 when bracing member 266 of support assembly 206 is in the second expanded position or an intermediate position between the first contracted position and the second expanded position.

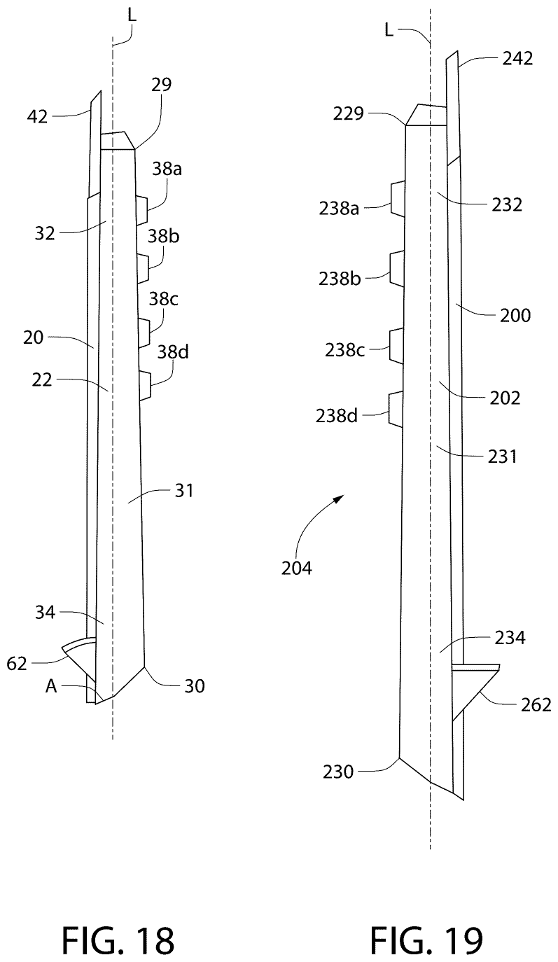

In some non-limiting implementations, as seen in FIG. 18, transmitting device 20 may have at least one transmitting member 22 and a transmitting assembly 24 positioned within and supported by transmitting member 22. Transmitting member 22 may have a first end 29, a second end 30, at least one sidewall 31 that extends along the longitudinal axis L between first end 29 and second end 30. A bore (not shown) may extend from first end 29 of transmitting member 22 to second end 30 of transmitting member 22 along longitudinal axis L and may be defined by an internal surface (not shown) of sidewall 31 that extends between first end 29 and second end 30 of transmitting member 22. Transmitting member 22 may have a first portion 32 and a second portion 34. First portion 32 of transmitting member 22 may be positioned adjacent first end 29 of transmitting member 22. Second portion 34 of the transmitting member 22 may be positioned adjacent second end 30 of transmitting member 22. Second end 30 of transmitting member 22 may have an angle of insertion A configured to fix transmitting device 20 at a predetermined location such that second end 30 of transmitting member 22 may be positioned below a surface as described above.

In some non-limiting implementations, transmitting assembly 24 of transmitting device 20 may be positioned within first portion 32 of transmitting member 22 such that the one or more transmitters 38 of transmitting assembly 24 may be positioned between a height of approximately 36 inches to approximately 56 inches above surface S. By way of example, but in no way limiting, as seen in FIG. 18, first transmitter 38a of transmitters 38 may be the distance D1 from surface S and last transmitter 38d may be the distance D2 from surface S. In a preferred implementation, distance D1 of first transmitter 38a above surface S may be approximately 56 inches. In some preferred implementations, distance D2 of last transmitter 38n (as illustrated by 38d in FIG. 18) may be approximately 36 inches. In some non-limiting implementations, transmitting device 20 may have one or more positioning members 62 positioned on the one or more sidewalls 31 of second portion 34 of transmitting member 22 of transmitting device 20.

In some non-limiting implementations, as seen in FIG. 19, receiving device 200 may have at least one receiving member 202 and a receiving assembly 204 positioned within and supported by receiving member 202. Receiving member 202 may have a first end 229, a second end 230, at least one sidewall 231 that extends along longitudinal axis L between first end 229 and second end 230. A bore (not shown) may extend from first end 229 of receiving member 202 to second end 230 of receiving member 202 along the longitudinal axis L and may be defined by an internal surface (not shown) of sidewall 231 that extends between first end 229 and second end 230 of receiving member 202. Receiving member 202 may have a first portion 232 and a second portion 234. First portion 232 of receiving member 202 may be positioned adjacent first end 229 of receiving member 202. Second portion 234 of receiving member 202 may be positioned adjacent second end 230 of receiving member 202. Second end 230 of receiving member 202 may have an angle of insertion A configured to fix receiving device 200 at a predetermined location such that second end 230 of receiving member 202 may be positioned below surface S.

In some non-limiting implementations, receiving assembly 204 of the receiving device 200 may be positioned within first portion 232 of receiving member 202 such that receivers 238 of receiving assembly 204 may be positioned between a height of approximately 36 inches to approximately 56 inches above surface S. By way of example, but in no way limiting, as seen in FIG. 18, first receiver 238a of receivers 238 may be distance D1 from surface S and last receiver 238d may be distance D2 from surface S. In some preferred implementations, distance D1 of first receiver 238a above surface S may be approximately 56 inches. In some preferred implementations, distance D2 of last receiver 238n (as illustrated by 238d in FIG. 18) may be approximately 36 inches. In some non-limiting implementations, receiving device 200 may have one or more positioning member 262 positioned on sidewalls 231 of second portion 234 of receiving member 202 of transmitting device 200.

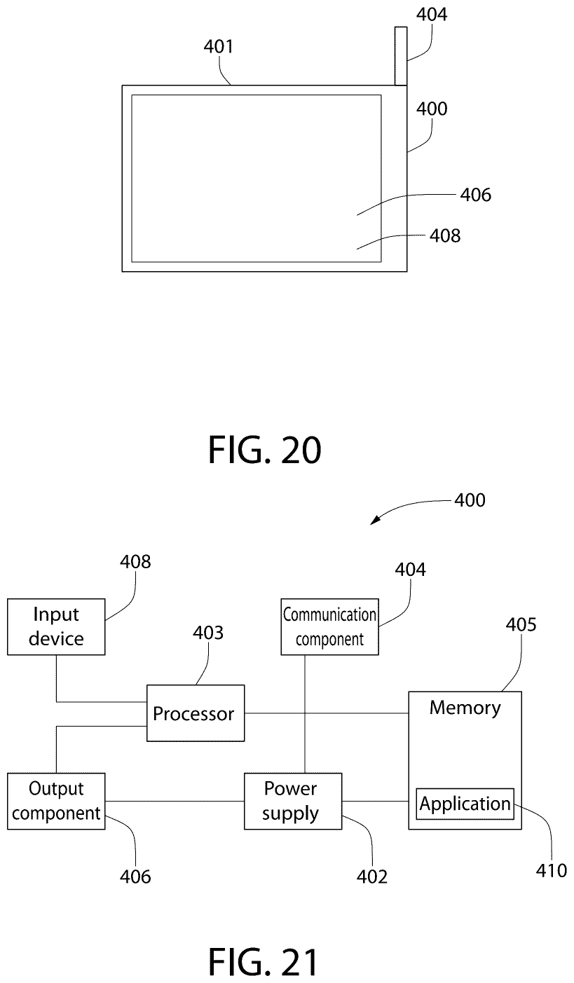

FIG. 20 discloses an exemplary illustration of pendant device 400 and FIG. 21 discloses a diagrammatic view of exemplary pendant device 400 of system 10. Pendant device 400 of system 10 may have housing 401, power supply 402 configured to supply power to the components of pendant device 400, processor(s) 403, communication component(s) 404 capable of interfacing with network 21, non-transitory computer readable medium 405 (hereinafter “memory”) storing processor executable code and/or software application(s), for example, including a web browser capable of accessing a website and/or communicating information and/or data over network 21, and/or the like. In some non-limiting implementations, pendant device 400 may have output component(s) 406. In some non-limiting implementations, pendant device 400 may have input device(s) 408.

Processor(s) 403 of pendant device 400 may be a single processor or multiple processors working together, or independently, configured to execute the processor executable code and/or software application(s) as described herein. Processor(s) 403 may also be configured to creating, manipulating, retrieving, altering, and/or storing data structures in memory 405 of pendant device 400 or a database of the external system, like a cloud-based system (not shown). Processor(s) 403 may be a unitary multi-core processor. Examples of processor(s) 403 may include, but are not limited to, a digital signal processor (DSP), a central processing unit (CPU), a field programmable gate array (FPGA), a microprocessor, a multi-core processor, combinations thereof and/or the like. Processor(s) 403 may be configured to communicate with memory 405 via a data path (e.g., data bus). Processor(s) 403 may be configured to communicate with output component 406 and/or input device 408. In some non-limiting implementations, processor(s) 403 of pendant device 400 may execute processor executable instructions and/or code stored within the structured database, program logic, and/or application 410 of pendant device 400 such that pendant device 400 communicates a discoverable signal via communication component 404 of pendant device 400. Processor(s) 403 may also be configured to interface and/or communicate with transmitting device 20, receiving device 200, and/or the external system (or mobile device) via the network 21. For example, processor(s) 403 may be configured to communicate with transmitting device 20, receiving device 200, and/or the external system via the network 21 by exchanging data signals (e.g. analog, digital, optical, and/or the like) through communication component 404 of pendant device 400. Processor(s) 403 may be configured to use network protocol to provide updated information to an application 410 executed on pendant device 400 received via one or more port (not shown) of pendant device 400 and/or via an external source.

Communication component 404 of pendant device 400 may be configured to bi-directionally communicate one or more data signals (e.g., analog, digital, optical, and/or the like) with transmitting device 20, receiving device 200, and/or an external system such as a cloud-based network using network protocol to exchange data signals. In some implementations, communication component 404 of pendant device 400 of system 10 may be configured to interface and/or communicate with an external system via the network 21 or an external network (not shown). In some non-limiting implementations, communication component 404 of pendant device 400 may be configured to generate, establish, maintain, and/or host network 21 with transmitting device 20, receiving device 200, or an external system (not shown), as described above.

In some non-limiting components, communication component 404 may be an operator device such as an antenna, a Wi-Fi enabled device, Bluetooth enabled device, radio frequency enabled device, or the like. The antenna may be RF, Bluetooth, or the like. In other non-limiting components, the communication component 404 may be lower frequency RF, longer range LORA WAN, XBEE, Thread, Bluetooth, Zigbee, or the like.

Memory 405 of pendant device 400 may have one or more structured database (not shown) and/or program logic (not shown). In some non-limiting implementations, memory 405 of pendant device 400 may have one or more applications 410. Memory 405 may be configured to store processor executable code and/or information within the structured database and/or program logic.

The structured database of memory 405 of pendant device 400 may be a database, a data table, or the like. The structured database may include processor executable instructions and/or code capable of being executed by processor(s) 403, that when executed by processor(s) 403 causes processor(s) 403 to generate an output in a form perceivable by a user; generate, maintain, provide, and/or host the network 21 consisting of transmitting device 20, receiving device 200, and pendant device 400; generate, maintain, provide and/or host network 21 consisting of transmitting device 20, receiving device 200, pendant device 400, and an external system such as a cloud-based network.

The program logic of memory 405 may have processor executable instructions and/or code, which when executed by processor(s) 403, may cause processor(s) 403 to execute the commands programmed within the instructions and/or code. The processor executable instructions and/or code of the program logic may cause processor(s) 403 to execute the commands programmed within the instructions and/or code to generate an output in a form perceivable by a user; generate, maintain, provide, and/or host network 21 consisting of transmitting device 20, receiving device 200, and pendant device 400; generate, maintain, provide and/or host a network consisting of transmitting device 20, receiving device 200, pendant device 400, and an external system such as a cloud-based network. The processor executable instructions and/or code may be in the form of software and/or firmware, written in any suitable programming language. Suitable programming language may be C, C++, Python, Java, Javascript, SQL, and the like.

Memory 405 of pendant device 400 may also have applications 410 that may comprise processor executable instructions and/or code. In some non-limiting implementations, application 410 may be engaged by a user via pendant 400 or by way of a mobile device connected to network 21. By way of example, but in no way limiting, application 410 may be configured for a user to interact with a graphical user interface of application 410 responsive to an input by the user and to display an output via output component 406 of pendant device 400 or a mobile device connected to network 21. In some non-limiting implementations, application 410 of pendant device 400 of the mobile device just described, may be configured to manage the sporting event(s).

In some non-limiting implementations, the output may be the time interval of a participant of the sporting event, information approximately the participant in a sporting event, prior sporting event information, photographs, videos, musical videos, or the like. In some non-limiting implementations, the processor executable instructions and/or code of the application 410 that when executed by the processor 403 may cause the processor 403 to execute the commands programmed within the instructions and/or code to determine the order of participants in the sporting event, assign the determined time interval(s) to the participant of the sporting event, store the time interval(s) for the participants of the sporting event, or the like.

In some non-limiting implementations, the application 410 of pendant device 400 may operate in conjunction with the external system (such as a cloud-based network). As described above, pendant device 400, among other things, receives time interval data from receiving device 200 provides the received interval data to, for example, an event scoreboard for publication. Pendant 400 may be located above the event venue to provide increased opportunity to communicate as many transmitter/receiver gate pairs as are set up for the event (again, for a given closed network, for each desired split time, there will be a pair of transmitter device/receiver device, but only a single pendant device).

Output component 406 of pendant device 400 may be configured to output information in a form perceivable by the user. In some non-limiting implementations, output component 406 may be visual output component, auditory output component, haptic output component, and the like. In some limiting implementations, a visual output component 406 may be a display screen, a graphical user interface, touchscreen, website, a light, such as an LED, or the like. In some non-limiting implementations, output component 406 may be an auditory output component such as a horn, bell, or the like. Output component 406 may be a haptic output component 406 that may be configured to cause a user to receive a notification through a vibration, a pulse, or the like.

Input device 408 of pendant device 400 may be capable of receiving information input from the user and/or processor 403 of pendant device 400 and transmitting such information to other components of pendant device 400, transmitting device 20, receiving device 200, and/or external system (not shown). The external system may be a cloud-based system. Input device 408 may include, but is not limited to, a keyboard, touchscreen, mouse, trackball, microphone, fingerprint reader, infrared port, slide-out keyboard, flip-out keyboard, cell phone, PDA, remote control, fax machine, wearable communication device network interface, combinations thereof, and/or the like. It is to be understood that in some exemplary implementations, input device 408 and output device 406 may be implemented as a single device, such as, for example, a touchscreen of a computer, a tablet, or a smartphone. It is to be further understood that as used herein the term user is not limited to a human being, and may comprise a computer, a server, a website, a processor, a network interface, a human, a user terminal, a virtual computer, combinations thereof, and/or the like.

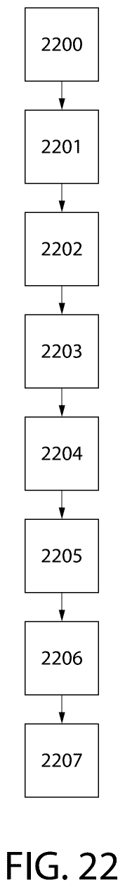

FIG. 22 is a flow diagram illustrating an exemplary method of determining a time interval of a sporting event. The method of determining a time interval of the sporting invent may include positioning transmitting device 20 at a first predetermined location (step 2200); positioning receiving device 200 at a second predetermined location opposite transmitting device 20 and at a distance D4 from transmitting device 20 (step 2201); establishing network 21 of the system (step 2203); aligning transmitters 38 of transmitting device 200 and receivers 238 of receiving device 200 (step 2204); arming electronic gate 54 of the system (step 2205); determining a time interval of the sporting event (step 2206); and communicating the determined time interval of the sporting event (step 2207).

Step 2200 may comprise positioning transmitting device 20 at a first predetermined location such that transmitting device 20 may be substantially perpendicular to surface S (step 2200). Transmitting device 20 may be positioned at a predetermined location via positioning second end 68 of member 60 of support assembly 26 of transmitting device 20 below surface S and within one or more subterranean material. In some non-limiting implementations, a force F may be applied on top surface 77 of positioning member 62 (see, e.g., FIG. 4) in the direction of surface S such that second end 68 of member 60 may be inserted into and positioned within the subterranean material (i.e., the ground) below surface S. In some non-limiting implementations, transmitting device 20 may be positioned at a predetermined location via positioning second end 30 of transmitting member 22 of transmitting device 20 below surface S and within one or more levels of subterranean material. In some non-limiting implementations, force F may be applied on top surface 77 of positioning member 62 in the direction of surface S such that second end 30 of transmitting member 22 may be inserted into and positioned within the subterranean material below surface S.

Step 2201 may comprise positioning receiving device 200 at a second predetermined location opposite transmitting device 20 such that receiving device 200 is positioned substantially perpendicular to surface S and receivers 238 of receiving assembly 204 of receiving device 200 are substantially aligned with transmitters 38 of transmitting assembly 24 of transmitting device 20 (as seen in FIG. 1). The second predetermined location of receiving device 200 may be a distance D4 from transmitting device 20. The distance D4 may be approximately 10 yards to approximately 150 yards. Receiving device 200 may be positioned at a predetermined location via positioning second end 268 of member 260 of support assembly 206 of receiving device 200 below surface S and within one or more layers of subterranean material.

In some non-limiting implementations, a force F may be applied on top surface 277 of positioning member 262 (see FIG. 12) in the direction of surface S such that second end 268 of member 260 may be inserted into and positioned within one or more layers of the subterranean material below surface S. In some non-limiting implementations, receiving device 200 may be positioned at a predetermined location via positioning second end 230 of receiving member 202 of receiving device 200 below surface S and within one or more layers of subterranean material. In some non-limiting implementations, a force F may be applied on top surface 277 of positioning member 262 in the direction of surface S such that second end 230 of receiving member 202 may be inserted into and positioned within the subterranean material below surface S.

Step 2202 may comprise establishing the network 21 of the system 10. In some non-limiting implementations, the network 21 may include the transmitting device 20, the receiving device 200, and one or more user device 400. In some non-limiting implementations, network 21 may include transmitting device 20, receiving device 200, pendant device 400, and may include an external system, such as a cloud-based network (not shown). In some non-limiting implementations, network 21 may be formed from transmitting device 20, receiving device 200 and pendant device 400. In some non-limiting implementations, network 21 may include transmitting device 20, receiving device 200, pendant device 400, and a connection to an external system, such as a cloud-based network (not shown). By way of example, but in no way limiting, the following disclosure shall reference network 21 having transmitting device 20, receiving device 200, and pendant device 400 of system 10.

In step 2202, establishing network 21 comprises engaging powering member 46 of transmitting device 20 such that transmitting device 20 is in an “ON” state wherein transmitting device 20 may be one node of network 21 such that transmitting device 20 may communicate a discoverable signal; engaging powering member 246 of receiving device 200 such that receiving device 200 is in an “ON” state wherein receiving device 200 may be a second node of network 21 such that receiving device 200 may communicate a discoverable signal; and engaging pendant device 400 such that pendant device 400 is in an “ON” state wherein pendant device 400 may be a third node of network 21 such that pendant device 400 may communicate a discoverable signal.

The “ON” state of transmitting device 20, receiving device 200, and pendant device 400 may comprise the components of transmitting device 20, receiving device 200, and pendant device 400 receiving power, respectively, from power supplies 45, 245, and 402. Communication component 42 of transmitting device 20 may receive the discoverable signal of receiving device 200 and discoverable signal of pendant device 400; communication component 242 of receiving device 200 may receive the discoverable signal of transmitting device 20 and the discoverable signal of the of pendant device 400; and communication component 242 of pendant device 400 may receive the discoverable signal of transmitting device 20 and the discoverable signal of receiving device 200, any of which can thereby establishing network 21 of the system based on the discoverable signals. In some instances, it may be preferable for receiving device 200 to establish network 21 given that receiving device 200 performs time interval calculations and determinations.

In some non-limiting implementations, wherein transmitting device 20, receiving device 200, and pendant device 400 are in an “OFF” state. The “OFF” state of transmitting device 20, receiving device 200, and pendant device 400 may comprise the components of transmitting device 20, receiving device 200, and pendant device 400 not receiving power from, respectively, power supplies 45, 245, and 402. In some non-limiting implementations, when one of the nodes of the network 21 (i.e., transmitting device 20, receiving device 200, and pendant device 400, or combinations thereof) is in an “OFF” state, the other nodes of network 21 that are in an “ON” state may send a signal to pendant device 400 and/or a user device such as a mobile phone (not shown) in a form perceivable by the user thereby notifying the user which node(s) is (are) in an “OFF” state. The user device may be a smartphone, a computer, a laptop, a tablet, or the like.

Step 2204 may comprise substantially aligning transmitters 38 of transmitting device 20 with receivers 238 of receiving device 200. Transmitting device 20 may be configured to be the “ON” state such that transmitters 38 may be transmitting a light signals 52 (as illustrated in FIGS. 23A-D and FIG. 24). Receiving device 200 may be configured to be in the “ON” state such that receivers 238 of receiving assembly 204 may be configured to receive the light signals 52 from transmitters 38 of transmitting device 20. Receivers 238 of receiving device 200 may be configured to determine the quality of light signals 52 communicated by transmitters 38 of the transmitting device 20. The quality of light signals 52 may be the strength, brightness, or the like. In some non-limiting implementations, transmitting device 20 may have processor executable instructions or code within structured database 56 and/or program logic 58 of transmitting assembly 24 that when executed by processor(s) 41 of transmitting assembly 24 causes the transmitters to communicate light signals 52 at a first frequency level.

If receivers 238 do not receive light signals 52 from transmitters 38, processor(s) 41 of transmitting device 20 may execute processor executable instructions or code stored within structured database 56 and/or program logic 58 that when executed by processor(s) 41 may increase the frequency of light signals 52 communicated by transmitters 38 to a second frequency level. If receivers 238 do not receive light signals 52 from transmitters 38 at the second frequency level, the transmitting device may execute processor executable instructions or code stored within structured database 56 and/or program logic 58 that when executed by processor(s) 41 may increase the frequency of light signals 52 communicated by transmitters 38 to a third frequency level. In some non-limiting implementations, processor(s) 41 of transmitting device 20 may increase the frequency of light signals 52 until light signals 52 are received by receivers 238 of receiving device 200. Upon receivers 238 of receiving device 200 recognizing light signals 52 communicated from transmitters 38 of transmitting device 20, receiving device 20 may communicate a data signal to transmitting device 20 instructing transmitting device 20 to stop increasing the frequency of light signals 52 communicated by transmitters 38.

In some non-limiting implementations, the frequency level may depend on the environmental lighting conditions. In other non-limiting implementations, transmitting device 20 having processor executable instructions that when executed by processor(s) 41 causes processor(s) 41 to incrementally increase the frequency of light signals 52 communicated by transmitters 38 such that the frequency of light signals 52 of transmitters 38 may not be greater than a threshold frequency level such that receiving device 200 is overwhelmed by light signals 52 and the measurement of the first-time interval is affected. In some non-limiting implementations, the light signals may be communicated by transmitters 38 of transmitting device 20 as a pulse or series of pulses. In some non-limiting implementations, light signals 52 communicated by transmitters 38 may be an optical beam of light having a divergent angle of approximately 15 degrees thereby increasing the probability that transmitters 38 of transmitting device 20 may be in proper alignment with receivers 238 of receiving device 200.

Step 2205 may comprise arming electronic gate 54 of system 10. Transmitters 38 of transmitting device 20 may communicate light signals 52 (which may be described in the present example as light signals 52a-d, which may be construed as interchangeable with light signals 52) that may be received by each of receivers 238 of receiving device 200 (see, e.g., FIGS. 23A-D). Transmitters 38 of transmitting device 200 may communicate light signals 52 as a pulse or series of pulses. The pulse(s) may be transmitters 38 communicating light signals 52 for an amount of time T. In some implementations, light signals 52 may be modulated signals having a carrier frequency configured to allow receiving device 200 to receive and lock-in on light frequency may be approximately 1 kHz to approximately 1 MHz.

As illustrated in FIG. 23A, by way of example but in no way limiting, a first transmitter 38a of transmitting assembly 24 may communicate a first light signal 52a for a first time T1. First light signal 52a may be received by receivers 238 of receiving device 200. First light signal 52a may span the distance between first receiver 238a and last receiver 238n (as shown in FIG. 23A as 238d). In some non-limiting implementations, the distance between first receiver 238a and last receiver 238n of receivers 238 may be approximately 20 inches; e.g., between approximately 56 inches above surface S and approximately 36 inches above surface S. First light signal 52a communicated by first transmitter 38a may be from a height of approximately 56 inches above surface S such that light signal 52a may have a cone-like shape. In some non-limiting implementations, time T1 may be between approximately 1 microsecond and approximately 150 milliseconds.

As illustrated in FIG. 23B, second transmitter 38b of transmitting assembly 24 may communicate a second light signal 52b for a second period of time T2. Second light signal 52b may be received by receivers 238 of receiving device 200. Second light signal 52b may span the distance between first receiver 238a and last receiver 238n (as shown in FIG. 23A as 238d). In some non-limiting implementations, the distance between first receiver 238a and last receiver 238n of receivers 238 may be approximately 20 inches; e.g., between approximately 56 inches above surface S and approximately 36 inches above surface S. Second light signal 52b communicated by second transmitter 38b may be from a height less than the approximately 56 inches above surface S of first transmitter 38a such that second light signal 52b may have a cone-like shape. In some non-limiting implementations, time T2 may be between approximately 1 microsecond and approximately 150 milliseconds.

As can be seen in FIG. 23C, third transmitter 38c of transmitting assembly 24 may communicate a third light signal 52c for a third period of time T3. Third light signal 52c may be received by receivers 238 of receiving device 200. Third light signal 52c may span the distance between first receiver 238a and last receiver 238n (as shown in FIG. 23A as 238d). In some non-limiting implementations, the distance between first receiver 238a and last receiver 238n of receivers 238 may be approximately 20 inches; e.g., between approximately 56 inches above surface S and approximately 36 inches above surface S. Third light signal 52c communicated by third transmitter 38b from a height less than the height of second transmitter 38b such that third light signal may 52c have a cone-like shape. In some non-limiting implementations, the duration of time T3 may be between approximately 1 microsecond and approximately 150 milliseconds.

As shown in FIG. 23D, last transmitter 38n of transmitting assembly 24 may communicate a last light signal 52n for a duration of time Tn (shown as fourth transmitter 38d of transmitting assembly 24 transmitting a fourth light signal 52d). Last light signal 52n may be received by receivers 238 of receiving device 200. Last light signal 52n may span the distance between first receiver 238a and last receiver 238n (as shown in FIGS. 23A-24 a 238d). In some non-limiting implementations, the distance between first receiver 238a and last receiver 238n of receivers 238 may be approximately 20 inches; e.g., between approximately 56 inches above surface S and approximately 36 inches above surface S. Last light signal 52d communicated by last transmitter 38n from a height less than the height of transmitter 38n-1 such that last light signal 52n may have a cone-like shape. In some non-limiting implementations, the height of last transmitter 38n may be approximately a height of 36 inches. In some non-limiting implementations, the duration of time Tn may be between approximately 1 microsecond and approximately 150 milliseconds.

In some non-limiting implementations, transmitters 38 may communicate light signals 52 transmitters 38 of transmitting device 20 in a sequence. For example, the sequence could start with first light signal 52a communicated by first transmitter 38a for a time T1. Subsequently, second transmitter 38b may communicate a second light signal 52b for a time. Subsequently, the remaining transmitters 38 of transmitting assembly 24 may communicate light signals 52x for a time TX, until last transmitter 38n communicates last light signal 52n. Upon the communication by last transmitter 38n of the last light signal 52n, the sequence would begin again with first transmitter 38a followed by transmitters 38b, 38c, . . . 38n.

In some non-limiting implementations, the duration of time T may be consistent for each transmitter 38 of transmitting assembly 24. In some non-limiting implementations, the duration of time T1-Tn may be approximately 150 microseconds. In some non-limiting implementations, the duration of time T1-Tn may be between approximately 0 milliseconds to approximately 500 microseconds. In some non-limiting implementations, the duration of time T1-Tn may not be consistent for the each of transmitters 38 of transmitting assembly 24.

In some non-limiting implementations, a period of time of the sequence of communication of first light signal 52a to last signal 52n may be approximately 1 microsecond to approximately 600 milliseconds. By way of example but in no way limiting, the period of time of the sequence of communication of first light signal 52a to last signal 52n may be a period of time of approximately 2 milliseconds. For example, the period of time of the sequence of communication of first light signal 52a to last light signal 52n may be approximately 20 microseconds. In other non-limiting implementations, transmitting assembly 24 may have one or more FPGA chips that may be configured such that the sequence be a period of time of approximately 0.1 milliseconds.

As can be seen in FIG. 24, the sequential communication of light signals 52 from each of transmitters 38 of transmitting assembly 24 such that light signals 52 may be received by receivers 238 of receiving assembly 204 thereby generating electronic gate 54 from light signals 52. In some non-limiting implementations, electronic gate 54 has a height of approximately 20 inches; e.g., electronic gate 54 may be projected from approximately 36 inches above surface S to approximately 56 inches above surface S (for a total of 20 inches in height). Persons skilled in the art will appreciate that the height of gate 54 can be varied by, for example, adding one or more transmitter/detector pairs to the respective devices (for example, with five transmitters and receivers instead of four) in order to make the span larger.

Step 2206 may comprise determining the time interval of the sporting event. Determining a time interval of the sporting event may comprise determining a first interruption of light signals 52 communicated by transmitters 38 of transmitting device 20, and may include determining which light signals 52 from which transmitters 38 and by which receivers 238 were affected by the interruption and for how long. The first interruption of light signals 52 communicated by transmitters 38 may be determined by system 10 when one or more light signals 52 are not received by one of the one or more receivers 238 for a period of time BT.

The period of time BT may be approximately 20 milliseconds to approximately 500 milliseconds. In some non-limiting implementations, the period of time BT may be approximately 50 milliseconds. If the period of time BT of the interruption of light signals 52 is met, processor(s) 241 of receiving device 200 may process processor executable instructions causing processor(s) 241 to determine a first time stamp TS1. The first time stamp may be a time measured by clock component 249 of receiving device 200. In some non-limiting implementations, pendant device 400 may have a clock component (not shown) that may be configured to determine the first time stamp TS1.

Electronic gate 54 will rearm after a period of time RT thereby preparing for the participant to again pass through electronic gate 54 to conclude the time interval. In that instance, first time stamp T1 corresponds to the time when the participant started its event while second time stamp T2 marks the time when the participant cross gate 54 a second time ending the event for the participant. The difference between the first time stamp and the second time stamp is the time interval.

In some non-limiting implementations, the period of time RT to rearm electronic gate 54 may be between approximately 3 to approximately 10 seconds. Thus, determining the time interval of the sporting event may further comprise determining a second interruption of light signals 52 communicated by transmitters 38 wherein the light signals 52 are not received by one or more of receivers 238 for the period of time BT. If the period of time BT of the second interruption of light signals 52 is met, processor 241 of receiving device 200 may process processor executable instructions causing processor 241 to determine a second-time stamp TS2 (while processor 41 of transmitter device 20 and processor 403 of pendant device 400 could process interval times, in general, it would be more efficient for processor 241 to process interval times gives that the interruption in light signals is determined by receiving device 200). Second-time stamp may be a time measured relative to clock component 249 of receiving device 200.

Subsequently, processor 241 of receiving device 200 may determine the time interval of the sporting event by subtracting TS1 from TS2. The determining of the time interval may be via precision time protocol method. The precision time protocol may achieve accuracy in the sub-microsecond range for the system.

Step 2207 may comprise transmitting device 20 and/or receiving device 200 communicating a signal indicative of the time interval of the sporting event to pendant device 400 which can cause the time interval to be displayed via output component 406 in a form perceivable by the user. Communication component 404 of pendant device 400 may receive the signal, thereby causing processor 403 to execute processor executable instructions that when executed by processor 403 causes processor 403 to send the time interval as an output signal via output component 406. In some non-limiting implementations, transmitting device 20, receiving device 200, and/or pendant device 400 may communicate the signal indicative of the time interval of the sporting event to a second user device, such as a mobile device.

In some non-limiting implementations, upon determining the first-time interval, transmitting device 20, receiving device 200, and/or pendant device 400 may communicate a signal indicative of the time interval to a database within a cloud-based network, website, or other online consumers of a race telemetry or the like. The signal communicated from transmitting device 20 and/or receiving device 200 may include the time interval, the location of the sporting event, the type of sporting event, and the like.

In some non-limiting implementations, the system may be configured to measure one or more subsequent time interval via the methods disclosed herein. Transmitting device 20 and/or receiving device 200 may communicate signals indicative of one or more subsequent time intervals to pendant device 400 for display via output component 406. In some non-limiting implementations, transmitting device 20, receiving device 200, and/or pendant device 400 may communicate signals indicative of one or more subsequent time intervals to an external system, such as a cloud-based network, or the like. In some non-limiting implementations, transmitting device 20, receiving device 200, and/or pendant device 400 may communicate signals indicative of one or more subsequent time intervals to a second user device such as a mobile device. The signals may also include the number of the time intervals, the order of performance, the type of sporting event, the location of the sporting event, information about the participant, and the like.

In some implementations, non-limiting the methods described herein may further comprise determining the order of participants in the sporting event, assigning the determined time interval(s) to the one or more participants of the sporting event, storing of the time interval(s) for the participants in the sporting event in the application of pendant device 400 and/or in a mobile device.

In some non-limiting implementations, transmitting device 20, receiving device 200, and pendant device 400 may be enabled with Wi-Fi connectivity such that transmitting device 20, receiving device 200, and pendant device 400 may communicate with an external network, such as the internet, to communicate the determined time interval(s) to an external system such as a cloud-based network, or the like.

Conventionally, there is a need to develop a system and method for determining accurate time interval(s) for participants in sporting events. The present disclosure by way of example, but in no way limiting, addresses this need.

The foregoing description provides illustration and description but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred implementation. Further, the phrase “based on” is intended to mean “based, at least in part, on” unless explicitly stated otherwise.

Persons skilled in the art will appreciate that elements of any device herein may be utilized in any device herein. Persons skilled in the art will also appreciate that the present invention is not limited to only the embodiments described. Instead, the present invention more generally involves transmitting and receiving a series of light signals that can form a gate of light through which event participants can pass in order to determining interval timing of the event. Persons skilled in the art will also appreciate that the apparatus of the present invention may be implemented in other ways then those described herein. All such modifications are within the scope of the present invention, which is limited only by the claims that follow.

1. A system for determining timing of an event comprising:
a wireless data network comprising a plurality of nodes;
a beam transmitter device that operates on said wireless data network as one of said plurality of nodes, said beam transmitter comprising a plurality of light generating devices that each transmit light;
a beam receiver device that operates on said wireless data network as one of said plurality of nodes, said beam receiver comprising a plurality of optical detectors that are each configured to detect light transmitted by at least one of said plurality of light generating devices of said beam transmitter, wherein said beam receiver processes disruptions in detected light into determined time intervals of said event; and
a pendant device that operates on said wireless data network as one of said plurality of nodes, said pendant device operating in communication with said beam transmitter, and said beam receiver to receive said determined time intervals that corresponds to a termination of IR light being received by at least one of said plurality of optical detectors, said pendant operating to report said timing of said event to a display.

2. The system of claim 1 further comprising:
a mobile communications device that operates on said wireless data network as one of said plurality of nodes, wherein said mobile communication device communicates with said pendant device.

3. The system of claim 1, wherein said transmitted light and said detected light are in the infrared spectrum.

4. The system of claim 1, wherein said beam transmitter device further comprises:
a processor that controls when each light generating device transmits light such that none of the light generating devices transmits light when any other light generating device is transmitting light and that said light generating devices are activated to cause them to transmit light in a specific sequence.

5. The system of claim 1, wherein said beam receiver device further comprises:
a clock generator that generates a clock signal;
a processor that monitors when light received by each optical detector is disrupted relative to said clock signal, said processor designating a first disruption as a start time of an individual event and designating a second disruption as an end time of said individual event, said processor determining said interval time as a different between said start time and said end time.

6. The system of claim 1, wherein the plurality of light generating devices comprises:
a first light generating device;
a second light generating device positioned vertically between said first light generating device and a support assembly;
a third light generating device positioned vertically between said second generating device and said support assembly; and
a fourth light generating device positioned vertically between said third light generating device and said support assembly.

7. The system of claim 6, wherein said first light generating device is positioned approximately 56 inches above a surface.

8. The system of claim 6, wherein said fourth light generating device is positioned approximately 36 inches above a surface.

9. The system of claim 6, wherein a vertical distance between said first light generating device and said second light generating device is between 20 and 30 inches.

10. A method of determining a time interval in a sporting event comprising:
positioning a transmitting device at a first predetermined location, said transmitting device comprising a plurality of light transmitters;
positioning a receiving device at a second predetermined location opposite said transmitting device at a distance from the transmitting device, said receiving device comprising a plurality of light receivers;
positioning a pendant device at a height above said transmitting device and said receiving device;
establishing a network comprising said transmitting device, said receiving device, and said pendant device;
aligning said plurality of light transmitters with said plurality of light receivers;
activating said plurality of transmitters in a pre-determined sequence in order to generate an electronic gate between said transmitting device and said receiving device;
setting a first time stamp when light signals emitted by said plurality of transmitters are interrupted;
resetting said electronic gate after a predetermined amount of time passes after said first time stamp;
setting a second time stamp when light signals emitted by said plurality of transmitters are interrupted after said reset of said electronic gate occurred;
determining said time interval as a difference in time between said first time stamp and said second time stamp; and
transmitting said time interval to said pendant device.

11. The method of claim 10, further comprising:
establishing a clock component signal prior to said activating said plurality of transmitters to generate of said electronic gate; and
utilizing said clock component signal in determining said first time stamp and said second time stamp.

12. The method of claim 10 wherein activating said plurality of transmitters in a pre-determined sequence comprises:
activating a first transmitter of said plurality of transmitters for a time T1;
deactivating said first transmitter;
activating a second transmitter of said plurality of transmitters for a time T2;
deactivating said second transmitter;
activating a third transmitter of said plurality of transmitters for a time T3;
deactivating said third transmitter;
activating a fourth transmitter of said plurality of transmitters for a time T4; and
deactivating said fourth transmitter.

13. The method of claim 12, wherein T1, T2, T3, and T4 are all different times from each other.

14. The method of claim 12, wherein T1, T2, T3, and T4 are all the same amount of time.

15. The method of claim 14, wherein T1, T2, T3, and T4 are all approximately 500 milliseconds.
